(19) United States
(12) Patent Application Publication
(10) Pub. No.: US 2026/0145754 A1
(43) Pub. Date: May 28, 2026

(54) BICYCLE FRONT AND REAR RACK MOUNTING MECHANISMS

(71) Applicant: Specialized Bicycle Components, Inc., Morgan Hill, CA (US)

(72) Inventors: Brian Daniel Robinson, Newcastle, CA (US); Jamie Michael Stafford, Auburn, CA (US); Francis Robert Egger, Watsonville, CA (US)

(21) Appl. No.: 19/395,782

(22) Filed: Nov. 20, 2025

Related U.S. Application Data
(60) Provisional application No. 63/724,142, filed on Nov. 22, 2024.

(51) Int. Cl. B62J 7/04; B62J 1/08; B62J 7/06; B62K 3/02; B62K 25/28

(52) U.S. Cl. CPC B62J 7/04; B62J 1/08; B62K 3/02; B62K 25/28; B62J 7/06

(57) ABSTRACT

A bicycle includes a front wheel, a rear wheel, a main frame supported by the front wheel and by the rear wheel, a rear suspension pivotally coupled to the main frame at a pivot axis, and a rear rack secured at the pivot axis.

### CROSS-REFERENCE TO RELATED APPLICATIONS

This application claims priority to U.S. Provisional Patent Application No. 63/724,142, filed Nov. 22, 2024, the entire contents of which are incorporated herein by reference.

### BACKGROUND

The present invention relates to bicycles and specifically to bicycles including rack mounting mechanisms.

Typically, bicycles may include racks to carry objects such as cargo, child carriers, baskets, etc. Racks can be mounted to either the front or the rear of the bicycle, depending on the type of load and rider preference. However, racks are generally designed for specific bicycle geometries and sizes, which means they are often not adaptable to different-sized bicycle frames.

### BRIEF DESCRIPTION OF THE DRAWINGS

FIG. 1 is a right-side view of a bicycle including a front rack assembly and a rear rack assembly, according to an embodiment.

FIG. 2 is a right-side perspective view of the bicycle of FIG. 1.

FIG. 3 is a perspective view of the rear rack assembly of the bicycle of FIG. 1.

FIG. 4A is a front view of the rear rack assembly of FIG. 3-.

FIG. 4B is a top view of the rear rack assembly of FIG. 3.

FIG. 4C is a side view of the rear rack assembly of FIG. 3.

FIG. 5 is an exploded view of a mounting assembly of the rear rack assembly of FIG. 3.

FIGS. 6A-6D are various views of a right mounting plate of the mounting assembly of FIG. 5.

FIGS. 7A-7B are front and rear perspective views of a right housing of the mounting assembly of FIG. 5.

FIGS. 7C-7D are perspective views of the right mounting plate and the right housing of the mounting assembly of FIG. 5 with the right mounting plate in a first position and a second position.

FIG. 8 is a perspective view of a seatpost clamp of the mounting assembly of FIG. 5.

FIGS. 9A-9B are perspective views of the rear rack assembly of FIG. 3, illustrating the seatpost clamp in an upward position and a downward position.

FIG. 10 is a perspective view of a front rack assembly.

FIG. 11 is a top view of the front rack assembly of FIG. 10.

FIG. 12 is a side view of the front rack assembly of FIG. 10.

FIG. 13 is a front view of the front rack assembly of FIG. 10.

FIG. 14 is an exploded perspective view of the front rack assembly of FIG. 10.

FIG. 15 is a perspective view of upper and lower accessory mounts from the front rack assembly of FIG. 10.

FIG. 16 is a side view of the upper and lower accessory mounts and mounting struts from the front rack assembly of FIG. 10.

FIG. 17 is a front view of the upper and lower accessory mounts and mounting struts from the front rack assembly of FIG. 10.

FIG. 18 is a perspective view of an alternative lower accessory mount.

FIGS. 19-22 illustrate a process of assembling the front rack assembly onto a bicycle.

FIGS. 23-27 illustrate various views of a light assembly that can be mounted to the front rack assembly of FIG. 10.

FIG. 28 is a right side perspective view of the bicycle of FIG. 1, with a front rack assembly according to a different example, and a rear rack assembly according to a different example.

FIG. 29 is a right side perspective view of the bicycle of FIG. 28, with a portion of the rear rack assembly removed.

FIG. 30 is an exploded view of the rear rack assembly of FIG. 28.

FIG. 31 is a partial, right side perspective view of a location of an upper pivot mount, and the rear rack assembly of FIG. 28.

FIG. 32 is a cross-sectional view taken along lines 32-32 in FIG. 31.

FIG. 33 is an exploded view of the front rack assembly of FIG. 28.

FIG. 34 is an exploded view of the front rack assembly and a headset assembly.

### DETAILED DESCRIPTION

Before any examples of the invention are explained in detail, it is to be understood that the disclosure is not limited in its application to the details of construction and the arrangement of components set forth in the following description or illustrated in the following drawings. The disclosure is capable of other examples and of being practiced or of being carried out in various ways.

In accordance with one example, a bicycle may include a front wheel, a rear wheel, a main frame supported by the front wheel and by the rear wheel, a rear suspension pivotally coupled to the main frame at a pivot axis, and a rear rack assembly secured at the pivot axis.

In accordance with another example, a bicycle may include a front wheel, a rear wheel, a main frame supported by the front wheel and the rear wheel, and a rack assembly coupled to and supported by the main frame. The rack assembly may include a rack base and an adjustable mount assembly coupled to the rack base. The adjustable mount assembly may be configured to facilitate attaching the rack assembly to different frame sizes.

In accordance with another example, a bicycle may include a front wheel, a rear wheel, and a frame assembly supported by the front wheel and by the rear wheel, the frame assembly including a main frame and a fork assembly rotatably secured to the main frame. The fork assembly may include a fork crown. The bicycle may further include a lower bearing that facilitates rotation of the fork assembly relative to the main frame about a steering axis, and a lower accessory mount including a base portion sandwiched between the fork crown and the lower bearing.

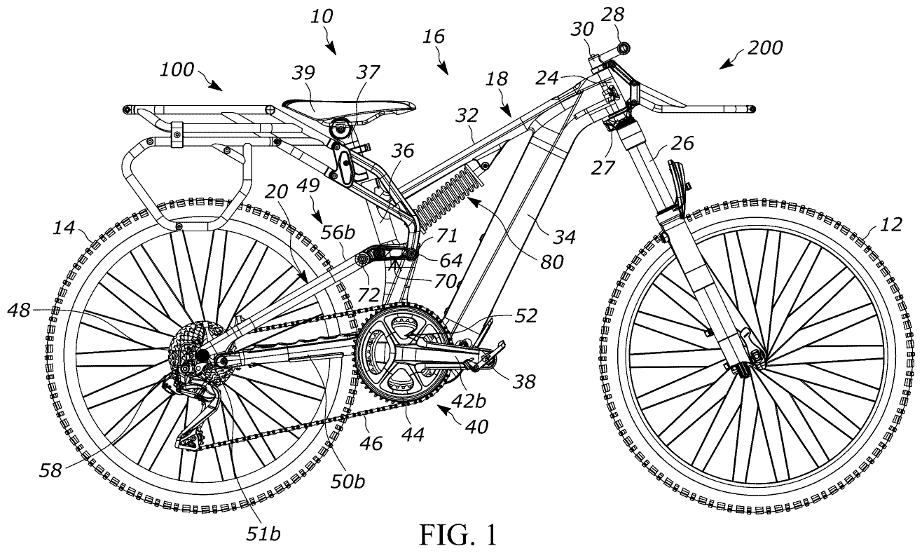

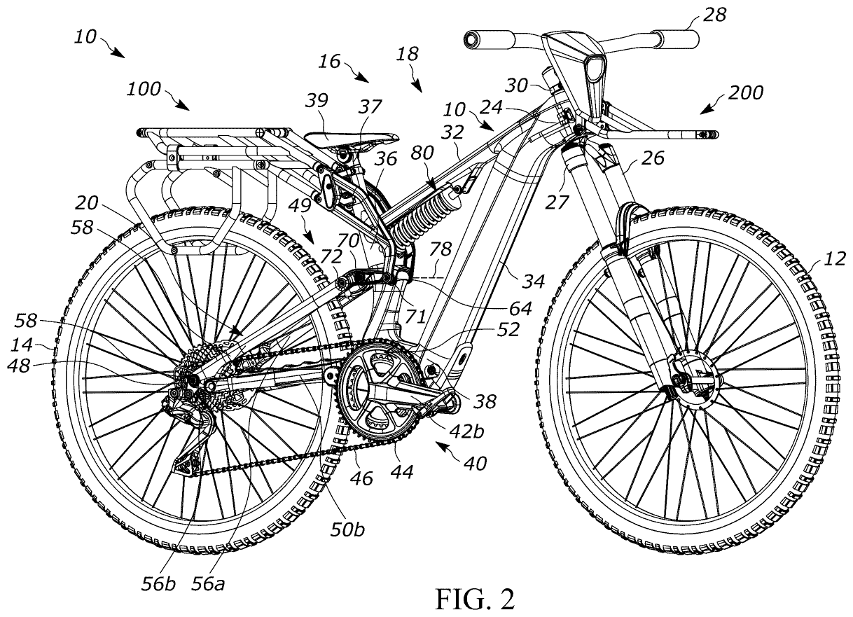

FIGS. 1-2 show a bicycle 10. The bicycle 10 is illustrated as a mountain bicycle, but in other examples the bicycle 10 may be an electric, active bicycle (e.g., urban bicycle), a road bicycle, a gravel bicycle, a hybrid bicycle, and/or any other type of bicycle, including any type of analog or electric bicycle.

With continued reference to FIGS. 1 and 2, the bicycle 10 may include a front wheel 12, a rear wheel 14, and a frame assembly 16 supported by the front wheel 12 and the rear wheel 14. The frame assembly 16 may include a main frame 18 and a rear frame 20. Although a particular configuration of the frame assembly 16 is illustrated, in other examples the bicycle 10 may be implemented with other configurations of the frame assembly 16 than that which is illustrated. In these examples, the frame assembly 16 may be implemented with other configurations having different shapes, sizes, and/or frame components.

The main frame 18 may include a head tube 24 and a front fork 26 having a fork crown 27 rotationally supported by the head tube 24. The front fork 26 may secure the front wheel 12 to the main frame 18. A handlebar assembly 28 may be coupled to the head tube 24 and be secured to the front fork 26 by a handlebar stem 30 such that rotation of the handlebar assembly 28 results in rotation of the handlebar stem 30 and the front fork 26.

The main frame 18 may also include a top tube 32, a down tube 34, a seat tube 36, a seatpost 37, and/or a bottom bracket 38. The seatpost 37 may support a seat 39. The bottom bracket 38 may rotationally support a crank assembly 40 having left and right crank arms 42a and 42b (only 42b being visible in FIGS. 1 and 2), and a chainring 44. The chainring 44 may drive a chain 46, which provides motion to a rear cog 48 on the rear wheel 14. The seat tube 36 may support an upper pivot mount 64.

The rear frame 20 may include a rear suspension assembly 49, which enables controlled movement of the rear wheel 14 relative to the main frame 18 to absorb shocks and vibrations. The rear suspension assembly 49 may include, for example, left and right chainstays 50a, 50b (only 50b being visible in FIGS. 1 and 2), left and right rear dropouts 51a, 51b (only 51b being visible in FIGS. 1 and 2), left and right seatstays 56a, 56b, a pivot link 70, and/or a rear shock 80.

The left and right chainstays 50a, 50b may be pivotally coupled to the main frame 18 at a lower pivot mount 52. The left and right seatstays 56a, 56b may be pivotally coupled to the left and right chainstays 50a, 50b at a rear pivot mount 58. The left and right chainstays 50a, 50b, the left and right seatstays 56a, 56b, and the pivot link 52 may cooperate to couple the rear wheel 14 to the main frame 18.

With continued reference to FIGS. 1-2, the pivot link 70, which may be considered an upper link, may include a front end 71 that is pivotally coupled to the main frame 18 at the upper pivot mount 64, and a rear end 72 that is pivotally coupled to upper ends of the left and right seatstays 56a, 56b. In some examples, a fastener (e.g., a bolt) may extend through the front end 71 of the pivot link 70 and the main frame 18, thereby securing the pivot link 70 to the main frame 18. In some examples, the pivot link 70, and therefore the rear suspension assembly 49, may be pivotally coupled to the main frame 18 at a pivot axis 78 (FIG. 2) defined by the upper pivot mount 64.

The shock 80 may be pivotally coupled, for example, between the main frame 18 and the pivot link 70. The shock 80 may provide resistance to articulating motion of the rear suspension assembly 49 relative to the main frame 18 and thus, provide resistance to the suspension travel of the rear wheel 14. Other examples of the bicycle 10 may not include a shock 80, or may include other types, numbers, and/or arrangements of shocks than that illustrated.

The above-described and illustrated structural arrangement of the rear suspension assembly 49 may, in some instances, provide a four-bar linkage with the four links being provided by the pivot link 70, the left and/or right seatstays 56a, 56b, the left and/or right chainstays 50a, 50b, and the seat tube 36 (e.g., between the upper pivot mount 64 and the lower pivot mount 52).

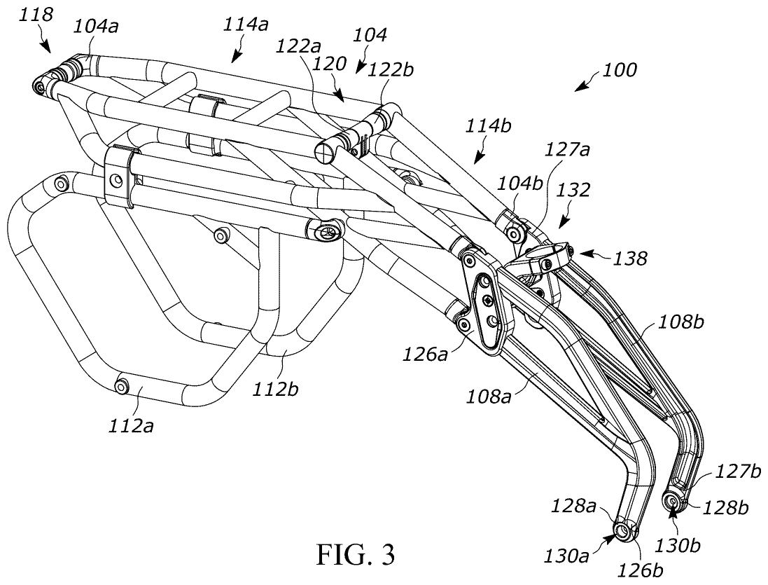

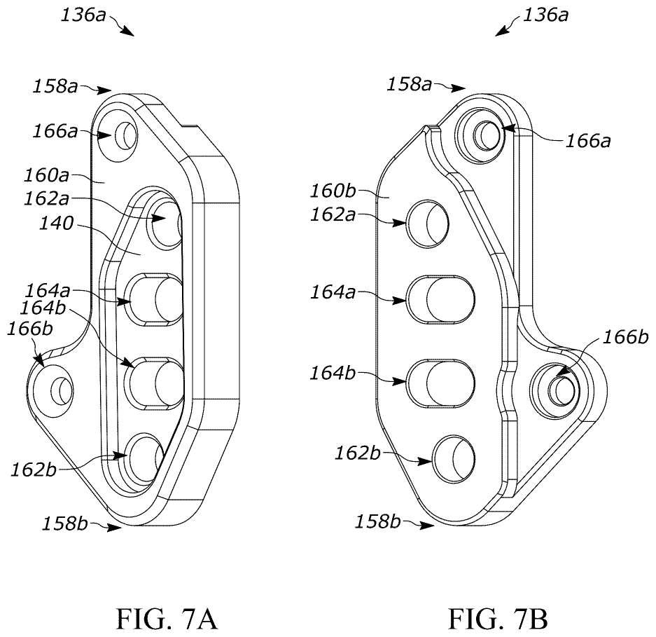

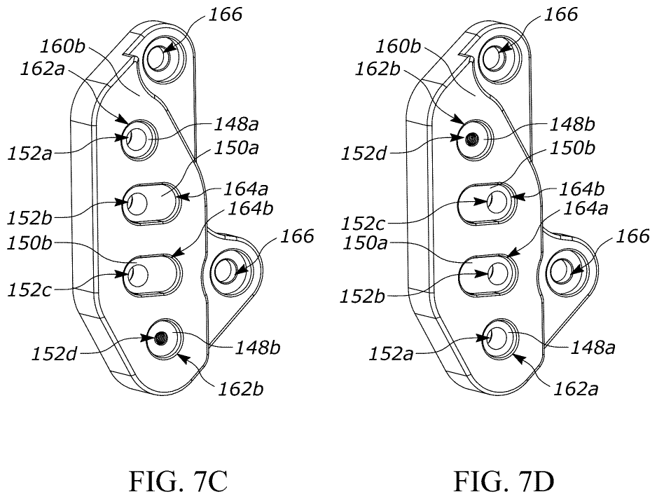

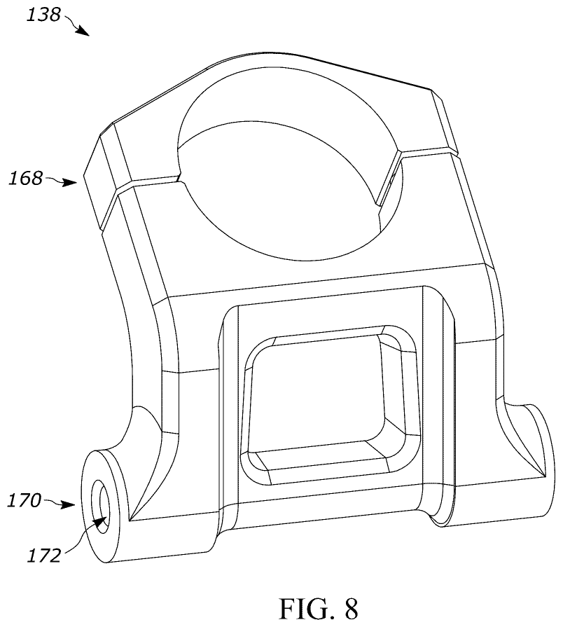

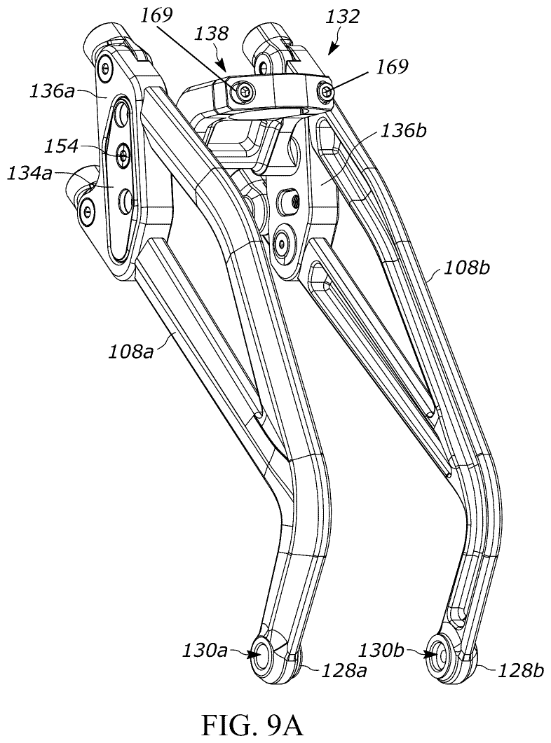

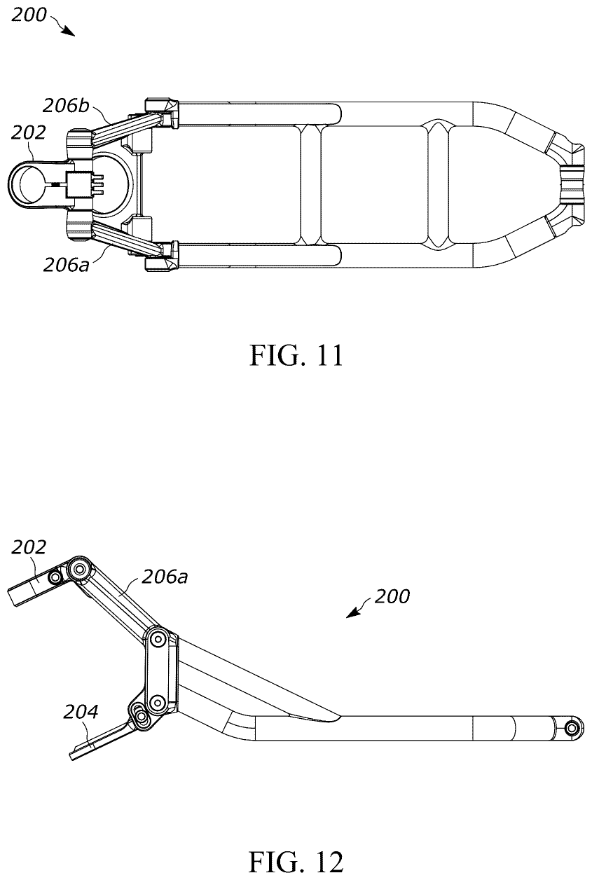

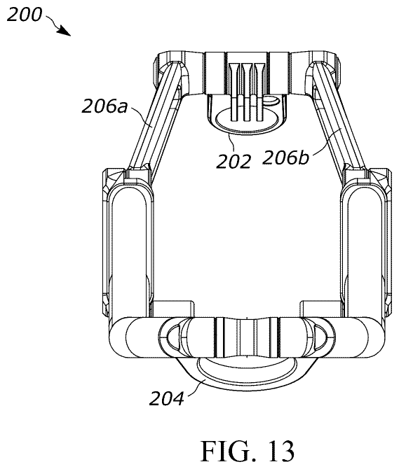

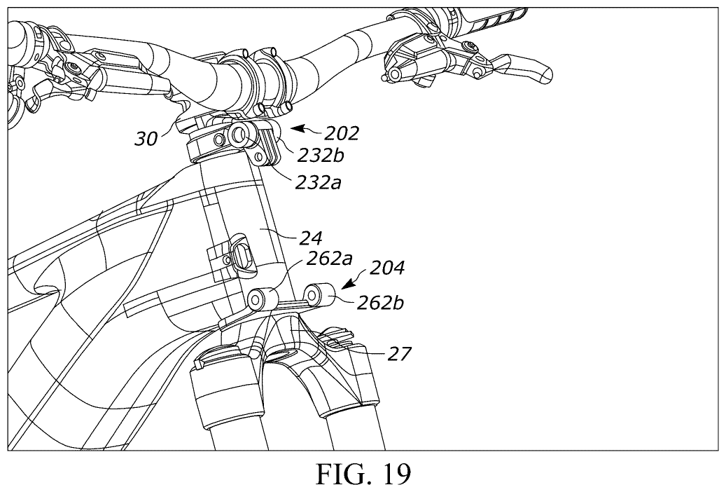

As discussed in more detail below, the bicycle 10 may include a rear rack assembly 100 and a front rack assembly 200 coupled to the main frame 18. FIGS. 3-9B illustrate the rear rack assembly 100 and FIGS. 10-22 illustrate the front rack assembly 200. In the illustrated embodiments, the term “rack” refers to anything that is designed to support an object on the bicycle, such as a cargo carrier, a child carrier, a basket, etc.

With reference to FIGS. 3-5, the rear rack assembly 100 may include a base 104, first and second support arms 108a, 108b, and/or first and second pannier structures 112a, 112b. The base 104 may include a rear end 104a, an opposite front end 104b that is coupled to the support arms 108a, 108b, a first (e.g., substantially flat or other shaped) portion 114a, and a second (e.g., angled or other shaped) portion 114b (angled for example at an oblique angle relative to the first portion 114a). In the illustrated example, the first portion 114a extends generally horizontally (e.g., parallel to a ground surface) when mounted to the main frame 18, although other examples may include other orientations. An upper surface of the first portion 114a may support various objects and a lower surface of the first portion 114a may removably support the first and second pannier structures 112a, 112b, which extend away from the base 104 on opposing sides of the rear wheel 14.

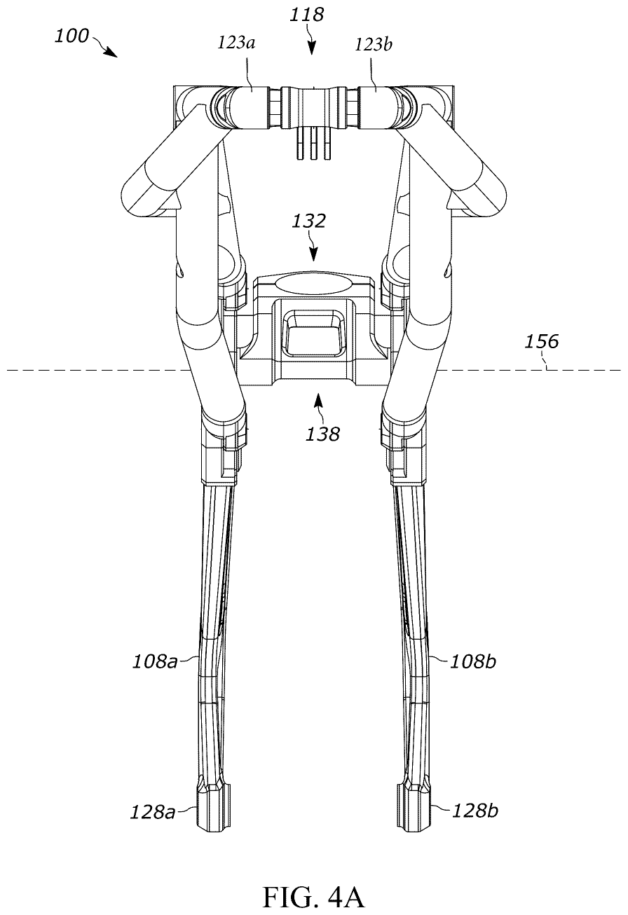

With continued reference to FIGS. 3-5, a rear accessory mount 118 may be positioned on the rear end 104a of the base 104 and/or a front accessory mount 120 may be positioned at a junction between the first portion 114a and the second portion 114b. The rear and front accessory mounts 118, 120 may facilitate a mounting location(s) for various accessories, such as an action camera or a light assembly. In some examples, the front accessory mount 120 may be mounted between a pair of front spacers 122a, 122b. In some examples, the rear accessory mount 118 may additionally or alternatively be mounted between a pair of rear spacers 123a, 123b (FIG. 4A).

The first support arm 108a may include a first end 126a that is coupled to the base 104, and a second end 126b that is coupled to the main frame 18 at the upper pivot mount 64. Similarly, the second support arm 108b may include a first end 127a that is coupled to the base 104, and a second end 127b that is coupled to the main frame at the upper pivot mount 64. In some examples, the first end 126a, 127a, of each support arm 108a, 108b may be coupled to the front end 104b of the base 104. The second end 126b, 127b of each support arm 108a, 108b may include a mount 128a, 128b, respectively, that is coupleable to the upper pivot mount 64 of the main frame 18. The mounts 128a, 128b may each include an aperture 130a, 130b, respectively, shaped and sized to receive a fastener to secure the support arms 108a, 108b to the upper pivot mount 64.

In some examples, each aperture 130a, 130b is shaped and sized to receive the same fastener that extends through the front end of the pivot link 70 and the main frame 18. The fastener may extend through the apertures 130a, 130b, the pivot link 70, and the main frame 18, thereby securing the support arms 108a, 108b, the rear rack assembly 100, and the pivot link 70 to the main frame 18 along the pivot axis 78.

By anchoring the rear rack assembly 100 to the main frame 18 at the upper pivot mount 64, the rear rack assembly 100 may support heavier loads more effectively, making it ideal for carrying cargo (e.g., panniers, touring gear, groceries, etc.). This configuration may also eliminate the need to transfer weight to a seatpost, which may not be designed for high vertical loads, thereby reducing stress and potential damage to the seatpost.

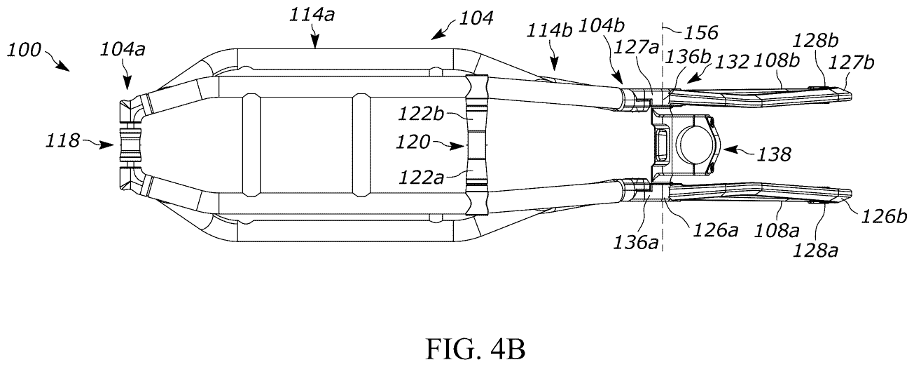

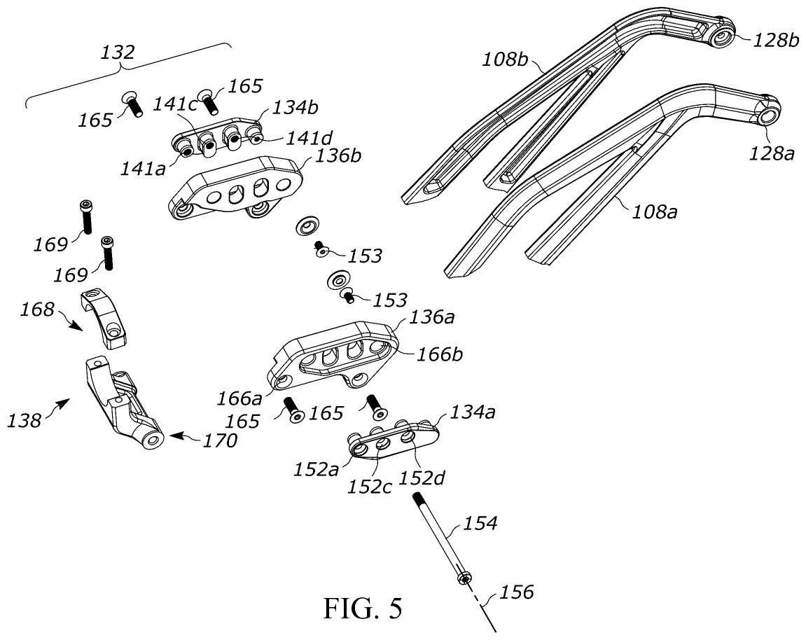

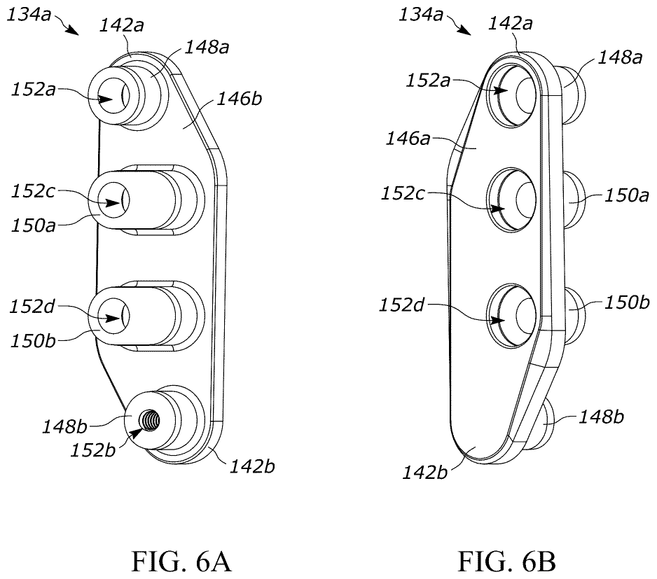

With reference to FIG. 5, the rear rack assembly 100 may additionally include an adjustable mount assembly 132, positioned adjacent the first ends 126a, 127a of the support arms 108a, 108b (or at other locations along the rear rack assembly 100). In some examples, the adjustable mount assembly 132 includes a first mounting plate 134a, a second mounting plate 134b, a first housing 136a secured to the first support arm 108a, a second housing 136b secured to the second support arm 108b, and a seatpost clamp 138 (also seen in FIG. 8) removably positioned between the first and second housings 136a, 136b. The seatpost clamp 138 may be considered an upper clamp, and in some examples may be secured between the seatpost 37 and the first and second mounting plates 134a, 134b. The first and second housings 136a, 136b may be shaped and sized to receive the first and second mounting plates 134a, 134b, respectively. That is, each of the first and second housings 136a, 136b may include a recess 140 (FIG. 7A) corresponding to the shape of the respective mounting plate 134a, 134b, such that the respective mounting plate 134a, 134b may be seated within the recess 140.

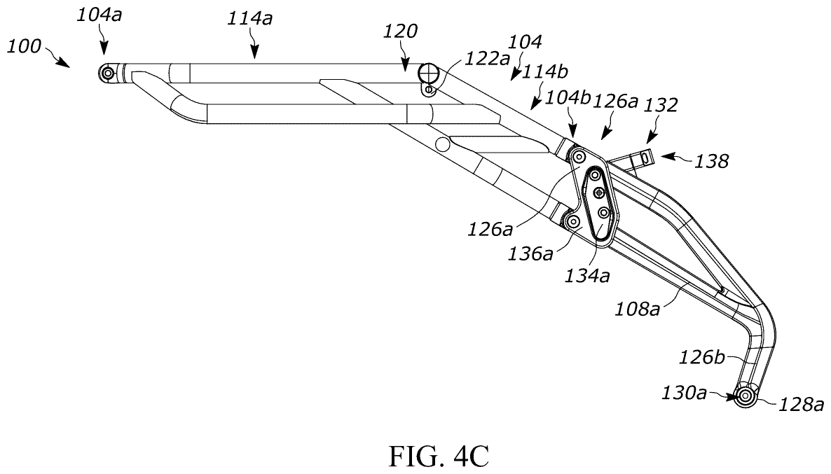

The first mounting plate 134a and the second mounting plate 134b may largely be mirror images of each other, with the only difference being the apertures. That is, the first mounting plate 134a may include countersunk apertures 152a, 152c, 152d (FIG. 6B), while the second mounting plate 134b may include threaded apertures (e.g., threaded through holes) 141a, 141c, 141d (FIG. 5).

The following description below (referring to FIGS. 6A-6D) references the first mounting plate 134a, but applies equally to the second mounting plate 134b. Accordingly, the second mounting plate 134b may include some or all of the features described below for the first mounting plate 134a, and in some examples, the second mounting plate 134b may be identical and/or a mirror image in size and/or shape and/or features to the first mounting plate 134a (with the exception for example of the apertures as described in the paragraph above).

With reference to FIGS. 6A-6D, the first mounting plate 134a may include a first end 142a, a second end 142b opposite the first end 142a, a longitudinal axis 144 (FIGS. 6C and 6D) longitudinally bisecting the first mounting plate 134a, a first (e.g., flat) face 146a, and a second (e.g., flat) face 146b opposite the first face 146a.

As seen in FIGS. 6A-6B, the first mounting plate 134a may have a generally parallelogram shape. In some examples, the first mounting plate 134a may have a rectangular shape or trapezoidal in shape. Other examples include various other shapes and/or sizes.

As illustrated in FIG. 6A, the first mounting plate 134a may include a series of bosses extending from the second face 146b. In some examples, the first mounting plate 134a may include a first (e.g., circular) boss 148a adjacent the first end 142a, a second (e.g., circular) boss 148b adjacent the second end 142b, a third (e.g., elliptical) boss 150a adjacent the first boss 148a, and a fourth (e.g., elliptical) boss 150b adjacent the second boss 148b. The first boss 148a may be offset relative to the second boss 148b along the longitudinal axis 144, while the third and fourth bosses 150a, 150b may be generally aligned along the longitudinal axis 144. In some examples, the first boss 148a and the second boss 148b may have a similar or identical shape. In some examples, the third boss 150a and the fourth boss 150b may have a similar or identical shape. Other examples may include various other arrangements and numbers of bosses having different shapes and/or sizes and/or orientations than that illustrated.

With continued reference to FIGS. 6A-D, the first mounting plate 134a may include a series of apertures, one through each of the bosses 148a, 148b, 150a, 150b. In some examples, the first (e.g., circular) boss 148a may include a first aperture 152a, the second (e.g., circular) boss 148b may include a second aperture 152b, the third (e.g., elliptical) boss 150a may include a third aperture 152c, and the fourth (e.g., elliptical) boss 150b may include a fourth aperture 152d. The first, third, and fourth apertures 152a, 152c, 152d may be countersunk through holes, allowing for fastening completely through the first mounting plate 134a. In contrast, the second aperture 152b may be a blind hole, extending only partially through the second (e.g., circular) boss 148b (i.e., through the second face 146b of the first mounting plate 134a). The second aperture 152b may be shaped and sized to receive a fastener 153 (FIG. 5) that couples the first mounting plate 134a to the first housing 136a. The first, third, and fourth apertures 152a, 152c, 152d may be shaped and sized to receive a main fastener 154 (FIG. 5) that couples the adjustable mount assembly 132 together and defines a fastener axis 156.

As illustrated in FIGS. 6C-6D, the apertures 152a-d may be offset from the longitudinal axis 144. That is, the first, third, and fourth apertures 152a, 152c, 152d may be positioned on one side of the longitudinal axis 144, and the second aperture 152b may be positioned on the other side of the longitudinal axis 144. In the illustrated example, the first mounting plate 134a includes four apertures. However, the first mounting plate 134a may include additional or fewer apertures. The three apertures (e.g., through-hole apertures) 152a, 152c, 152d may provide three distinct vertical mounting positions for the seatpost clamp 138. By aligning the seatpost clamp 138 with a specific aperture, the vertical height of the seatpost clamp 138 relative to the mounting plates 134a, 134b may be adjusted based on the needs of the user.

As noted above, the second mounting plate 134b may be a mirror image of the first mounting plate 134a, except the second mounting plate 134b has threaded apertures 141a, 141c, 141d instead of the countersunk apertures 152a, 152c, 152d of the first mounting plate 134a. Similarly, the first housing 136a and the second housing 136b may be mirror images of each other.

The following description below (referring to FIGS. 7A-7B) references the first housing 136a but applies equally to the second housing 136b. Accordingly, the second housing 136b may include some or all of the features described below for the first housing 136a, and in some examples, the second housing 136b may be identical and/or a mirror image in size and/or shape and/or features to the first housing 136a.

With reference to FIGS. 7A-7B, the first housing 136a may include a first end 158a, a second end 158b opposite the first end 158a, a first face 160a, and a second face 160b opposite the first face 160a. In some examples, the first housing 136a is generally flat, although other examples may include other shapes and/or sizes than that illustrated. As illustrated in FIGS. 7A-7B, the first face 160a may include the recess 140, which is shaped and sized to receive the first mounting plate 134a.

The first housing 136a may include a series of apertures extending therethrough. In some examples, the first housing 136a includes a first (e.g., circular) aperture 162a adjacent the first end 158a, a second (e.g., circular) aperture 162b adjacent the second end 158b, a third (e.g., elliptical) aperture 164a adjacent the first aperture 162a, and a fourth (e.g., elliptical) aperture 164b adjacent the second aperture 162b. Each aperture 162a, 162b, 164a, 164b may correspond to one of the bosses 148a, 148b, 150a, 150b on the first mounting plate 134a, 134b described above, such that the apertures 162a, 162b, 164a, 164b are shaped and sized to receive the bosses 148a, 148b, 150a, 150b, respectively. In some examples, the first (e.g., circular aperture 162a) may be sized to receive the first (e.g., circular) boss 148a, the second (e.g., circular) aperture 162b may be sized to receive the second (e.g., circular) boss 148b, the third (e.g., elliptical) aperture 164a may be sized to receive the third (e.g., elliptical) boss 150a, and the fourth (e.g., elliptical) aperture 164b may be sized to receive the fourth (e.g., elliptical) boss 150b.

In some examples, when the first mounting plate 134a is positioned within the recess 140 of the first housing 136a, each of the bosses 148a, 148b, 150a, 150b on the mounting plate 134a may extend into the corresponding aperture 162a, 162b, 164a, 164b on the first housing 136a, such that the first face 146a of the first mounting plate 134a sits flush with the first face 160a of the first housing 136a. In other examples, the first face 146a may not sit flush (e.g., may sit slightly below or above the first face 160a).

With continued reference to FIGS. 7A-7B, the first housing 136a may include two through-holes 166a, 166b that are each shaped and sized to receive a fastener 165 (FIG. 5) to secure the first housing 136a to the base 104 of the rear rack assembly 100. One through-hole 166a may be positioned adjacent the first end 158a, and the other through-hole 166b may be positioned adjacent the second (e.g., elliptical) aperture 164b. The fasteners 165 may extend through the through-holes 166a, 166b and into the second (e.g., angled) portion 114b of the base 104, securing the first housing 136a to the base 104.

The first and second mounting plates 134a, 134b may be used, for example, in two orientations-a first orientation (FIGS. 6A-6D and FIG. 7C) and a second orientation (FIG. 7D), where the mounting plates 134a, 134b are rotated or “flipped” 180-degrees relative to the fastener axis 156. In the first orientation, the first (e.g., circular) boss 148a is received in the first (e.g., circular) aperture 162a, the second (e.g., circular) boss 148b is received in the second (e.g., circular) aperture 162b, the third (e.g., elliptical) boss 150a is received in the third (e.g., elliptical) aperture 164a, and the fourth (e.g., elliptical) boss 150b is received in the fourth (e.g., elliptical) aperture 164b.

Conversely, in the second orientation, the first boss 148a is received in the second aperture 162b, the second boss 148b is received in the first aperture 162a, the third boss 150a is received in the fourth aperture 164b, and the fourth boss 150b is received in the third aperture 164a. As best shown by comparing FIG. 7C to FIG. 7D, flipping the first and second mounting plates 134a, 134b from the first orientation to the second orientation may move the positions of the countersunk apertures 152a, 152c, 152d and the corresponding threaded apertures 141a, 141c, 141d (which define the various mounting locations for the seatpost clamp 138) downward and rearward relative to the first and second housings 136a, 136b. This adjustment may allow the seatpost clamp 138 to be repositioned for a lower, more rearward mounting configuration, which can accommodate different bicycle frame geometries.

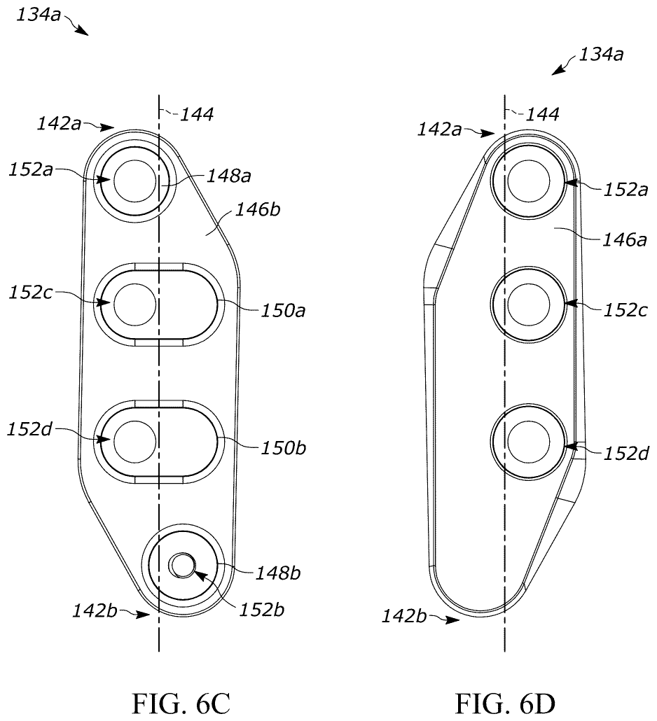

With reference to FIGS. 5, 8, 9A, and 9B, the seatpost clamp 138 itself may include a clamp portion 168 (FIGS. 5 and 8) dimensioned to be clamped to the seatpost 37 using one or more fasteners 169 (FIG. 5). The seatpost clamp 138 may further include a mounting portion 170 having a mounting hole 172 (FIG. 8) that can be positioned between the first housing 136a and the second housing 136b and secured by the main fastener 154. When being secured between the first and second housings 136a, 136b, the seatpost clamp 138 may be positioned in either an upward position (see FIG. 9A) or a downward position (see FIG. 9B).

To change the seatpost clamp 138 between the upward position and the downward position (and vice versa), the seatpost clamp 138 may be removed from the seatpost 37 (e.g., by removing the fasteners 169 and the clamp portion 168) and flipped over (e.g., 180 degrees) before again being clamped using the clamp portion 168. FIG. 9A illustrates one position (e.g., an upward position), while FIG. 9B illustrates a position in which the seatpost clamp 138 has been removed and flipped over 180 degrees (e.g., to a downward position). As seen in FIGS. 8, 9A, and 9B, the seatpost clamp 138 may have a bent, or angled, overall shape. In FIG. 9A, that angled shape curves in one direction, whereas in FIG. 9B the angled shape curves in a different direction, due to flipping the seatpost clamp 138 over. In some examples, an angular position of the seatpost clamp 138 overall relative to the first and second housings 136a, 136b may be adjustable. For example, additional positions other than the two flipped positions seen in FIGS. 9A and 9B may be possible.

As shown in FIGS. 9A-9B, in light of the above-described adjustments that may be made to the adjustable mount assembly 132, the seatpost clamp 138 may be positioned in numerous different positions relative to the first and second housings 136a, 136b. First, as described above, the seatpost clamp 138 may be secured to the first and second housings 136a, 136b to be aligned with any one of the through-hole apertures 152a, 152c, 152d to achieve three different vertical positions. Second, as described above, the seatpost clamp 138 may be flipped between the upward position and the downward position and then aligned with any one of the through-hole apertures 152a, 152c, 152d for a total of six positions. Third, as described above, a user may flip the mounting plates 134a, 134b to achieve six more total positions, for a total of twelve possible total positions of the seatpost clamp 138.

To adjust the mount assembly 132 to accommodate different bicycle frames, the main fastener 154 may be removed, and disengaged from the first and second mounting plates 134a, 134b, the first and second housings 136, 136b, and the seatpost clamp 138. To reposition the mounting plates 134a, 134b within the first and second housings 136a, 136b (i.e., from the first orientation to the second orientation), the fasteners 153 securing the first and second mounting plates 134a, 134b to the first and second housings 136a, 136b may be removed. Then, the first and second mounting plates 134a, 134b, may be removed, the first and second mounting plates 134a, 134b may be rotated 180-degrees about the fastener axis 156, and the first and second mounting plates 134a, 134b may be re-inserted within the recesses 140. Finally, the first and second mounting plate 134a, 134b may be secured in the second orientation by reinserting and tightening the fasteners 153.

To reposition the seatpost clamp 138, the seatpost clamp 138 may be disengaged from the first and second housings 136a, 136b and the seat tube 36. Then, the seatpost clamp 138 may be flipped 180-degrees, as described above, the seatpost clamp 138 may be repositioned between the housings 136a, 136b, and the seatpost clamp 138 may be aligned with the first and second housings 136a, 136b. The mounting hole 172 of the mounting portion 170 may then be aligned with the selected through-hole aperture 152a, 152c, 152d in the first and second mounting plates 134a, 134b to achieve the desired height. To secure the mount assembly 132, the main fastener 154 may be inserted through the selected aperture 152a, 152c, 152d, through the first and second housings 136a, 136b, and through the mounting hole 172, and the main fastener 154 may be threaded into the correspondingly aligned threaded aperture 141a, 141c, 141d to lock the mount assembly 132 into place.

The mount assembly 132 may allow the rear rack assembly 100 to be compatible with different sized bicycle frames. With the three through-hole apertures 152a, 152c, 152d on the first mounting plate 134a, the three threaded apertures 141a, 141c, 141d on the second mounting plate 134b, the ability to flip the plates 180-degrees, and the ability to flip the seatpost clamp 138 180-degrees, users may easily adjust the vertical and horizontal mounting positions to fit different frame geometries. While the illustrated example includes three through-hole apertures to accommodate three different vertical positions, it is understood that other examples may include other numbers (e.g., two, four, five, etc.) of apertures that may facilitate different vertical positions. Accordingly, while the illustrated example includes twelve total positions of the seatpost clamp 138, other examples may include fewer or more positions.

By virtue of the adjustability described above, the seatpost clamp 138 may be positioned close to the seat tube 36 if desired, reducing stress on the seatpost 37 and improving stability. The angular adjustability of the seatpost clamp 138 relative to the housings 136a, 136b may enhance the rear rack assembly's versatility by accommodating varying seat tube angles and frame dimensions. This adjustability may ensure a secure and optimal fit, improving the alignment and functionality of the rear rack assembly 100 while reducing cantilevered stress, ultimately enhancing the system's durability and performance.

FIGS. 10-17 illustrate the front rack assembly 200 in more detail. The front rack assembly 200 may include an upper accessory mount 202, a lower accessory mount 204, first and second mounting struts 206a, 206b (e.g., secured to the upper and lower accessory mounts 202, 204), and/or a front rack base 208 (e.g., secured to the first and second mounting struts 206a, 206b).

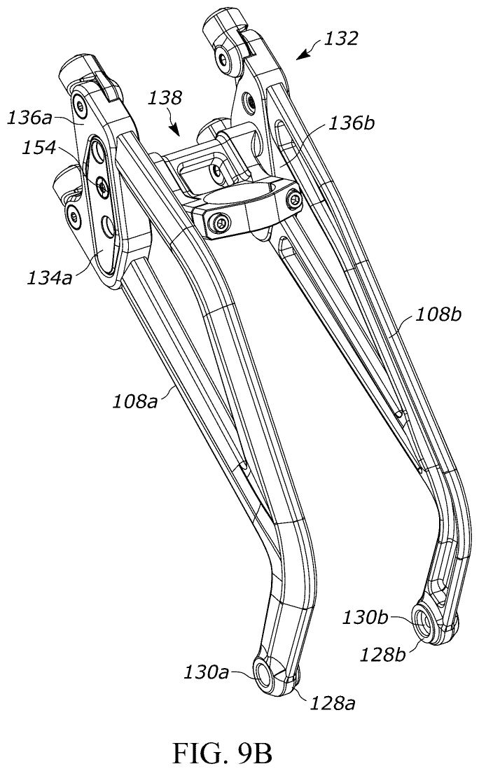

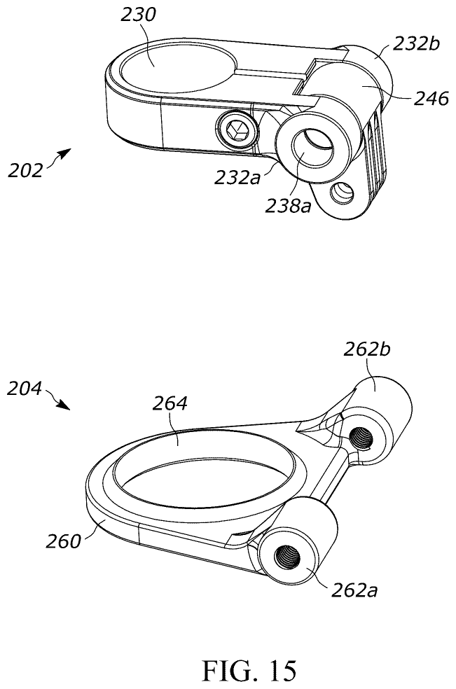

As illustrated in FIG. 14, the upper accessory mount 202 may include a steerer tube collar 230 and a pair of upper mounting bosses 232a, 232b. In some examples, the steerer tube collar 230 may be positioned, for example, between an upper headset bearing and the handlebar stem 30 (FIG. 19) in a location that is commonly occupied by headset spacers. In this regard, the steerer tube collar 230 may essentially act as a headset spacer until a set of headset bearings are preloaded, at which time the steerer tube collar 230 may be clamped to an upper portion of a steerer tube (e.g., by a collar bolt 234 and a barrel nut 236, or with other fasteners or clamps), as described below in more detail.

With reference to FIG. 14, in some examples, the upper mounting bosses 232a, 232b may each include a through-hole 238a, 238b, respectively, adapted to receive an upper mounting bolt 240 and an upper mounting nut 242 for securing an upper end of the first and second mounting struts 206a, 206b to the upper accessory mount 202. The upper accessory mount 202 may further include an upper spacer 244 positioned between the upper mounting bosses 232a, 232b.

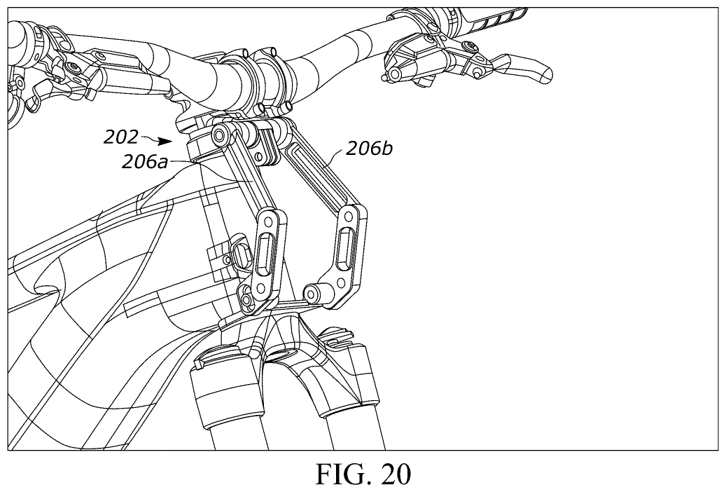

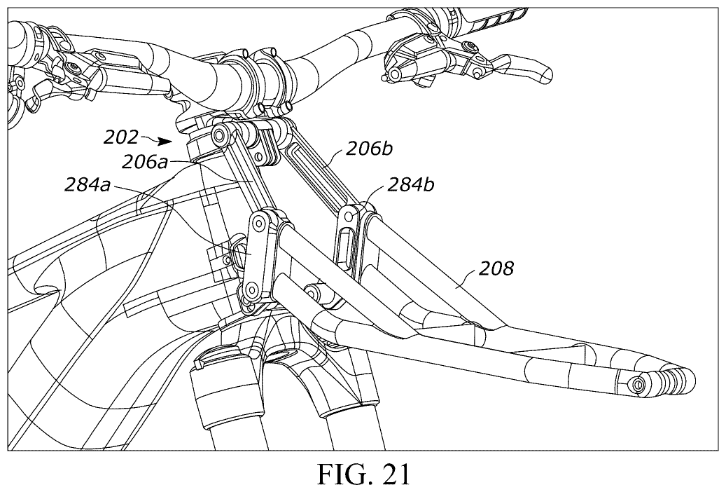

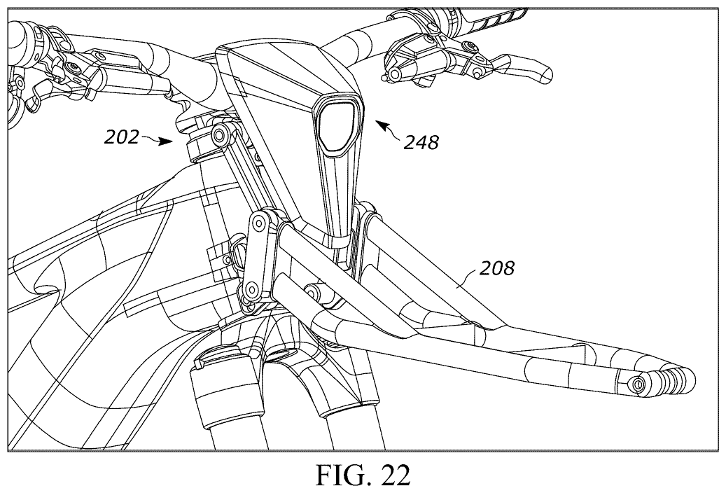

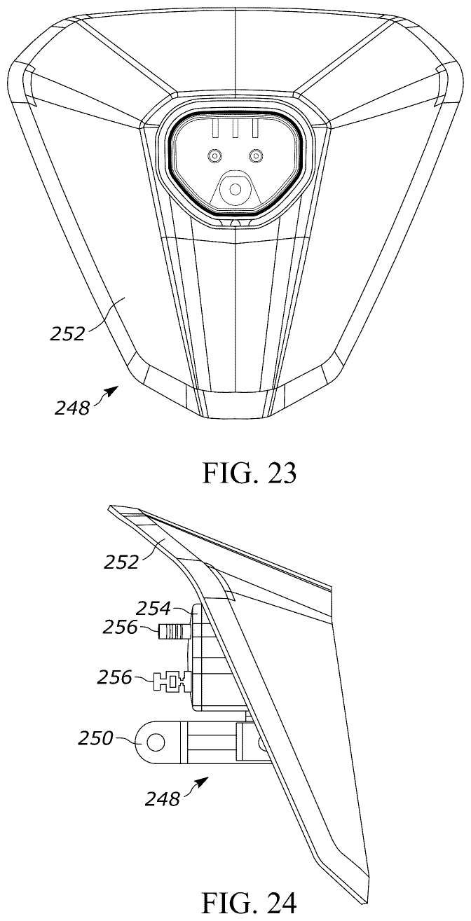

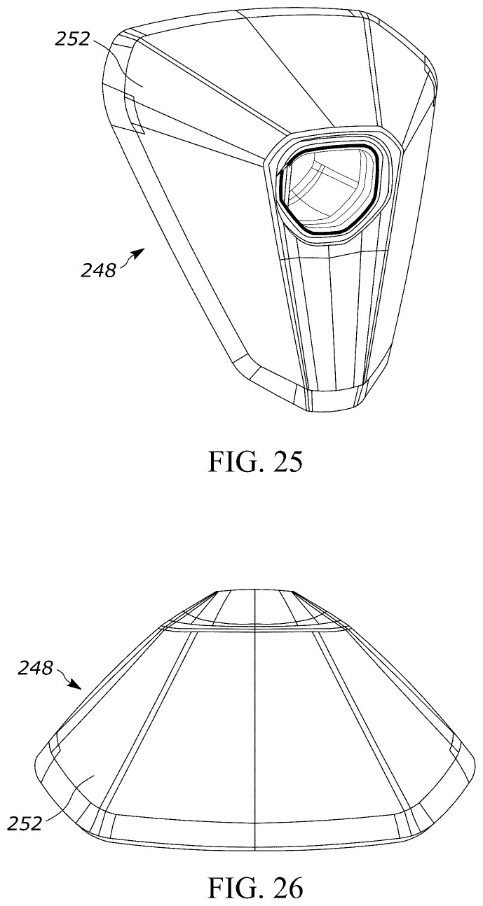

Alternatively, in a different embodiment, the upper spacer 244 may be replaced with a rear auxiliary accessory mount 246 that facilitates a mounting location for other accessories, such as an action camera or a light assembly 254. With reference to FIGS. 23-27, the light assembly 254 may form part of an overall headlight shield assembly 248. The headlight shield assembly 248 may include a shield mount 250 dimensioned to be secured to the rear auxiliary accessory mount 246, a shield body 252 supported by the shield mount 250, and the light assembly 254 mounted to the shield body 252. The light assembly 254 may include electrical contacts 256 designed to be coupled to a power source for powering the light assembly 254. As illustrated in FIG. 27, additional mounting locations 258 may be provided on a backside of the shield body 252 to provide alternative places to mount the shield body 252 to a bike or to provide locations for additional accessories, such as cable guides or lights.

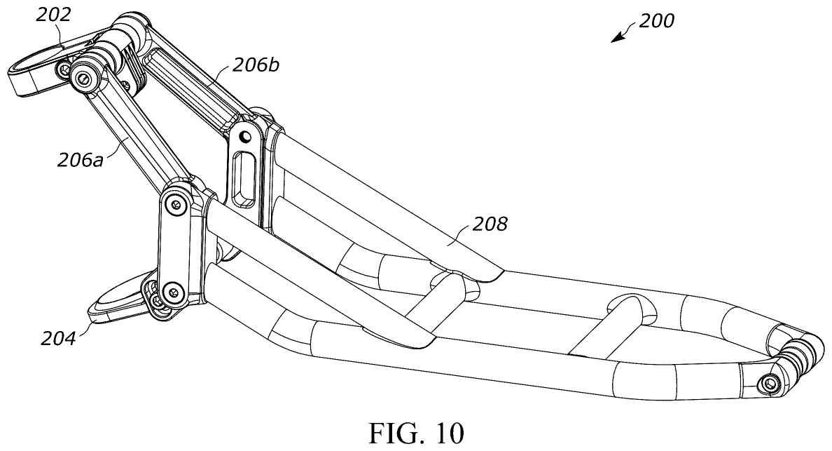

With reference to FIGS. 14 and 15, the lower accessory mount 204 may include a base portion 260 and a pair of lower mounting bosses 262a, 262b. The base portion 260 may comprise a substantially annular shape (e.g., a substantially annular disk) that substantially encircles a lower portion of the steerer tube of a bicycle (e.g., the bicycle 10). Other examples may include different shapes than that shown, and/or may not include the mounting bosses 262, 262b (e.g., may include other mounting regions or structures). In some examples, the lower accessory mount 204 may encircle a steerer tube, but may not encircle a head tube and/or a bearing.

In some examples, the base portion 260 may include a raised portion (e.g., having a beveled and/or frustoconical shape) 264 (FIG. 15) dimensioned to be received within and engage an inner race of a lower headset bearing of a headset for a bicycle (e.g., the bicycle 10). In this regard, the base portion 260 may be dimensioned to act as and replace a compression ring and/or fork crown race. In other examples, the base portion 260 may not act as a compression ring and/or fork crown race.

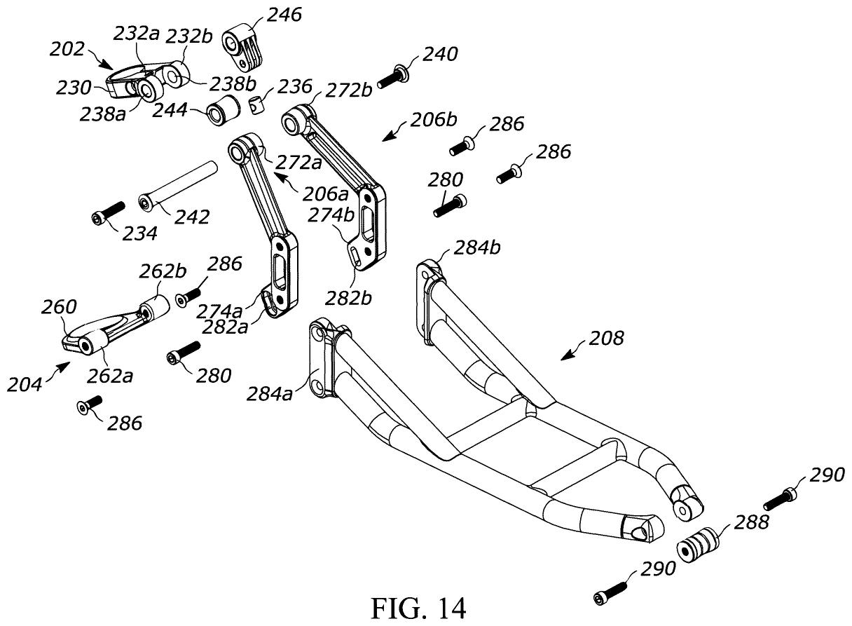

In an alternative embodiment shown in FIG. 18, an alternative base portion 266a may include a slotted portion 268 to facilitate compressive engagement with a steerer tube if/when a set of headset bearings are preloaded. This alternative embodiment may also include a single, wide mounting boss 270 instead of the two lower mounting bosses 262a, 262b illustrated in FIG. 15, although in other examples more than one mounting boss may be provided, or no mounting bosses may be provided. As illustrated in FIG. 18, the alternative base portion 266a still includes a raised portion 264a, similar to the raised portion 264, which may serve for example as a compression ring and/or fork crown race.

With reference to FIG. 14, in some examples the first and second mounting struts 206a, 206b (e.g., right and left mounting struts) may be dimensioned to align with and be secured to the upper mounting bosses 232a, 232b and the lower mounting bosses 262a, 262b. In particular, each mounting strut may include a respective upper mounting portion 272a, 272b and a lower mounting portion 274a, 274b that are adapted to be secured to the upper mounting boss 232a, 232b and the lower mounting boss 262a, 262b, respectively. The upper mounting portions 272a, 272b of the first and second mounting struts 206a, 206b may be secured to the upper mounting bosses 232a, 232b, respectively, utilizing the upper mounting bolt 240 and upper mounting nut 242.

The lower mounting portions 274a, 274b of the first and second mounting struts 206a, 206b may be secured to the lower mounting bosses 262a, 262b utilizing lower mounting bolts 280 threaded into the lower mounting bosses 262a, 262b. The illustrated lower mounting portions 274a, 274b each include a slotted orifice 282a, 282b, respectively, that facilitates use of the first and second mounting struts 206 on bicycle of various sizes. For example, as seen in FIG. 10, the slotted orifice 282a may allow the lower accessory mount 204 to be moved (e.g., vertically) toward or away from the upper accessory mount 202. Other examples may not include the slotted orifice 282a, or may include a larger slotted orifice to permit a greater degree of freedom of relative movement between the lower accessory mount 204 and the upper

### Accessory Mount 202.

With continued reference to FIG. 14, the front rack base 208 may include first and second mounting flanges 284a, 284b that are adapted to be secured to the first and second mounting struts 206a, 206b, respectively, utilizing rack mount bolts 286. The front rack base 208 may further include a rack spacer 288 secured by spacer bolts 290 on a front end of the front rack base 208. Alternatively, in a different embodiment, the rack spacer 288 may be replaced with a front auxiliary accessory mount that facilitates a mounting location for other accessories, such as an action camera or a light assembly 254. Other examples may include different numbers and/or arrangements of the bolts, spacer bolts, or other fasteners than that illustrated.

With reference to FIGS. 19-22, mounting the front rack assembly 200 to a bicycle (e.g., the bicycle 10 or other bicycle) may be initiated by mounting the upper accessory mount 202 and the lower accessory mount 204 to a fork assembly (which includes for example the front fork 26). In the illustrated embodiment, this is accomplished for example by removing the fork assembly from the head tube 24, sliding the lower accessory mount 204 onto the steerer tube, and re-inserting the steerer tube back into the head tube 24 such that the lower accessory mount 204 is sandwiched between the fork crown 27 and a lower headset bearing. The upper accessory mount 202 may then be slid onto the upper end of the steerer tube along with any needed headset spacers followed by the handlebar stem 30.

The upper and lower accessory mounts 202, 204 may then be aligned so that the mounting bosses (e.g., the upper mounting bosses 232a, 232b and the lower mounting bosses 262a, 262b) are facing directly forward (FIG. 19). The entire headset assembly may then be preloaded and the handlebar stem 30 may then be clamped to the steerer tube in a conventional manner. The collar bolt 234 may then be tightened to secure the upper accessory mount 202 to the steerer tube.

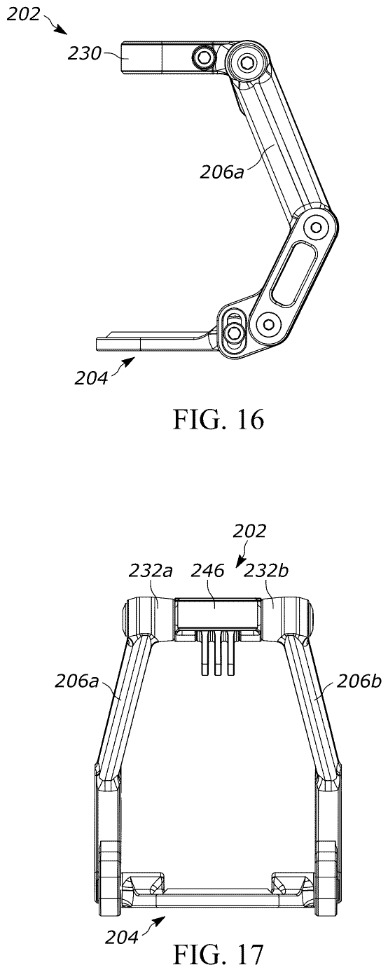

Next, and with reference to FIG. 20 (and also FIG. 14), the mounting struts 206a, 206b may be secured to the upper mounting bosses 232a, 232b using the upper mounting bolt 240 and the upper mounting nut 242. The upper spacer 244 may be positioned between the upper mounting bosses 232a, 232b before the upper mounting nut 242 is inserted through the through-holes 238a, 238b. If it is desired to mount an accessory to the upper mounting bosses 232a, 232b, then the rear auxiliary accessory mount 246 may be used in place of the upper spacer 244. The mounting struts 206a, 206b may also be secured to the lower mounting bosses 262a, 262b using the lower mounting bolts 280.

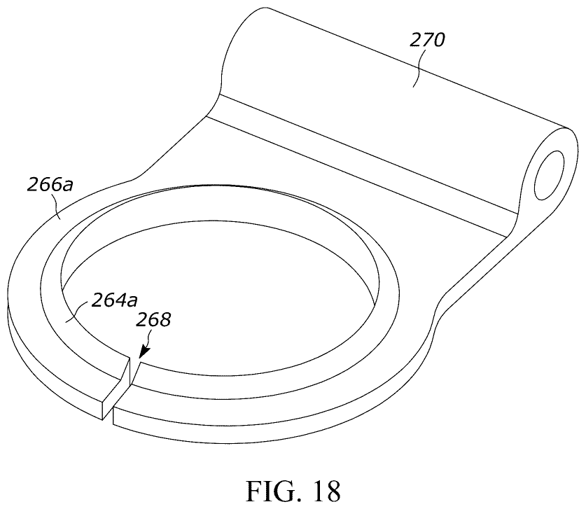

With reference to FIG. 21 (and also FIG. 14), the first and second mounting flanges 284a, 284b of the front rack base 208 may then be secured to the mounting struts 206a, 206b using the rack mount bolts 286. If it is desired to mount an accessory to the front of the front rack base 208, then a front auxiliary accessory mount may be used in place of the rack spacer 288.

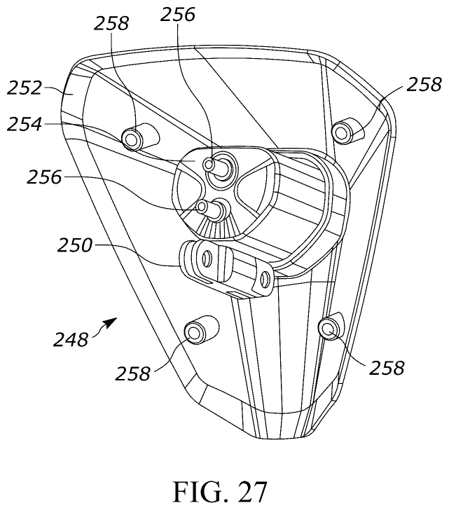

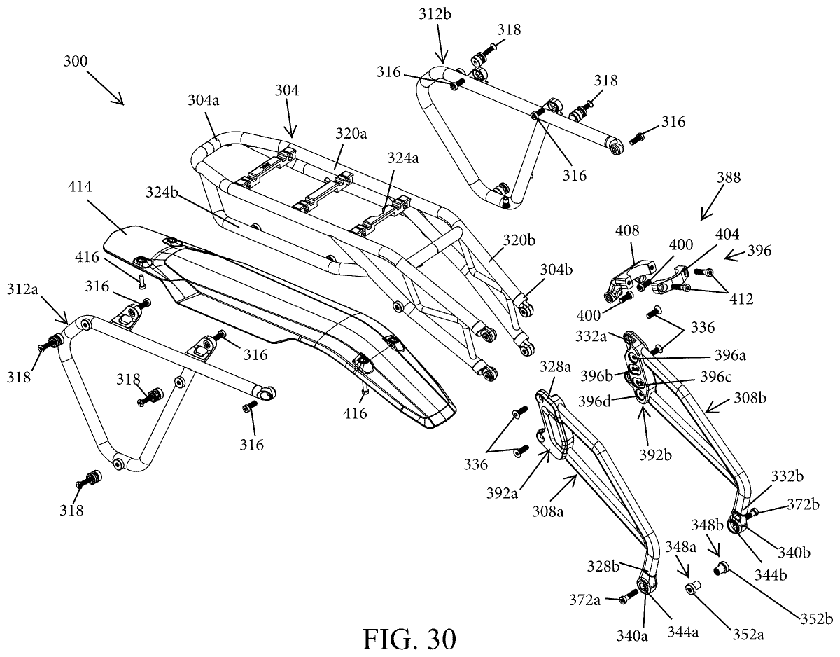

FIGS. 28-32 illustrate another example of a rear rack assembly 300. As illustrated in FIGS. 28-32, the rear rack assembly 300 may be coupled to the bicycle 10 (or to another bicycle), and in some examples may include many of the same components, or components similar to, the rear rack assembly 100.

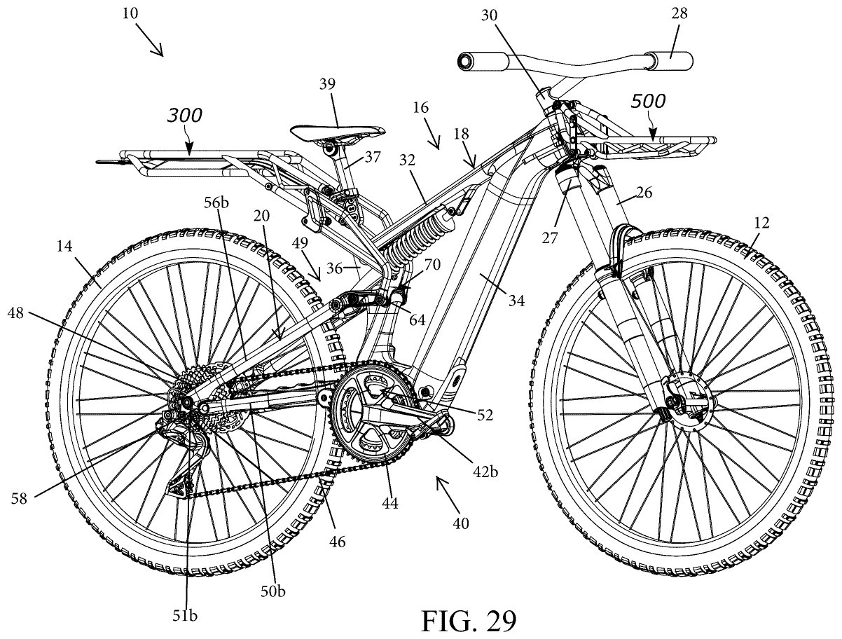

In some examples, and as seen in FIG. 30, the rear rack assembly 300 may include a base 304, first and second support arms 308a, 308b (e.g., right and left support arms), and/or first and second pannier structures 312a, 312b. Other examples may include different numbers of support arms and/or pannier structures than that illustrated (e.g., just a single support arm or pannier structure, three support arms or pannier structures, four support arms or pannier structures, etc.). In some examples, the rear rack assembly 300 may not include support arms, and/or may not include pannier structures.

With continued reference to FIG. 30, the first and second pannier structures 312a, 312b may be removably coupled to the base 304 with one or more fasteners 316. In other examples, the first and second pannier structures 312a, 312b may be integral with the base 304 (e.g., integrally formed as a single piece with the base 304) and not removable from the base 304.

In some examples, and as seen in FIG. 30, additional fasteners 318 may couple (e.g., be affixed) to the first and second pannier structures 312, 312b. The additional fasteners 318 may be used, for example, to attach additional items (e.g., cargo items or other items) to the first and second pannier structures 312a, 312b). Other examples may not include the additional fasteners 318, or may include other types, number, and/or arrangements of fasteners.

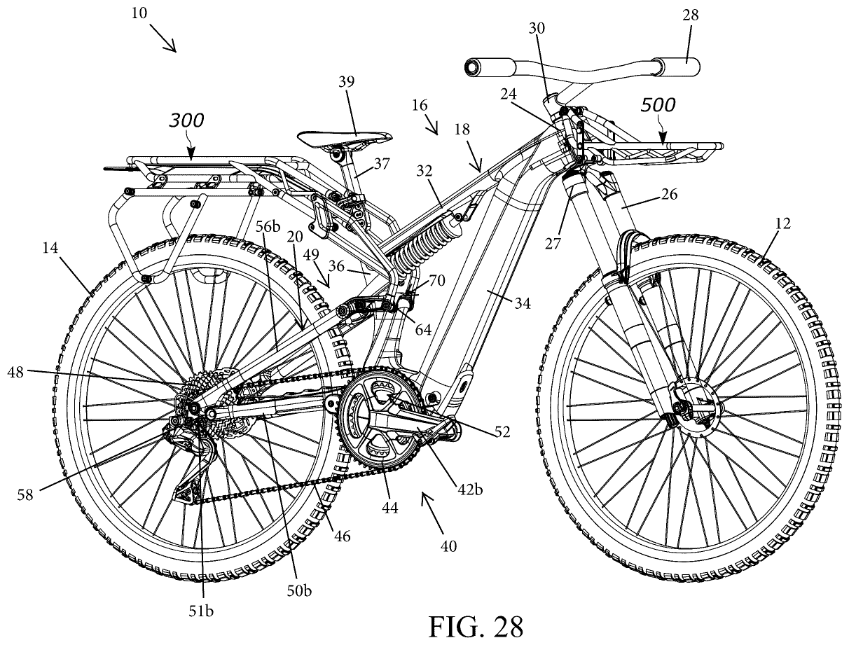

During use, and as seen in FIG. 28, the first and second pannier structures 312a, 312b may be used (e.g., to provided added support and/or protection to the rear wheel (e.g., the rear wheel 14). With reference to FIG. 29, in other examples, the first and second pannier structures 312, 312b may instead be removed.

With reference to FIG. 30, the base 304 may include a rear end 304a, and an opposite front end 304b that is coupled to the first and second support arms 308a, 308b. The base 304 may also include a first (e.g., substantially flat or other shaped) portion 320a, and/or a second (e.g., angled or other shaped) portion 320b (angled for example at an oblique angle relative to the first portion 320a). Other examples of the base 304 may include other numbers or arrangements of support arms, first portions, and/or second portions.

In the illustrated example, the first portion 320a may extend generally horizontally (e.g., parallel to a ground surface) when mounted to the bicycle frame (e.g., the main frame 18 of bicycle 10), although other examples may include other orientations. An upper region or surface 324a of the first portion 320a (e.g., a bar(s) or rod(s), etc.) may support various objects, and a lower region or surface 324b of the first portion 320a (e.g., a bar(s) or rod(s)) may removably support the first and second pannier structures 312a, 312b.

In some examples, the first and second pannier structures 312, 312b may extend away from the base 304 on opposing sides of the rear wheel 14. Other examples may include other arrangements. For example, the first and second pannier structures 312a, 312b may be supported by the upper region or surface 324a of the first portion 320a, or the first portion 320a of the base 304 may not include both the upper region or surface 324a and the lower region or surface 324b and instead may include just a single region that both supports various objects and also supports the first and second pannier structures 312a, 312b.

With continued reference to FIG. 30, in some examples the rear rack assembly 300 might not include a rear accessory mount, such as the rear accessory mount 118 of the rear rack assembly 100. However, in other examples the rear rack assembly 300 may include a rear accessory mount (e.g., similar to the rear accessory mount 118). Additionally, the rear rack assembly 300 might not include a front accessory mount, such as the front accessory mount 120 of the rear rack assembly 100. However, in other examples the rear rack assembly 300 may include a front accessory mount (e.g., similar to the front accessory mount 120).

With continued reference to FIG. 30, the first support arm 308a may include a first end 328a that is coupled to the base 304, and a second end 328b that is coupled to a bicycle frame (e.g., the main frame 18 of the bicycle 10) at an upper pivot mount (e.g., the upper pivot mount 64).

Similarly, the second support arm 308b may include a first end 332a that is coupled to the base 304, and a second end 332b that is coupled to the frame (e.g., the main frame 18 of the bicycle 10) at the upper pivot mount (e.g., the upper pivot mount 64).

In some examples, the first ends 328a, 332a, of each of the first and second support arms 308a, 308b may be coupled to the front end 304b of the base 304 with one or more fasteners 336. In other examples, the first support arm 308a and/or the second support arm 308 may be integrally formed as a single piece with the front end 304b of the base 304.

With continued reference to FIG. 30, the first and second support arms 308a, 308b may include first and second mounts 340a, 340b (e.g., right and left mounts), respectively, that are coupleable to the upper pivot mount of a bicycle frame (e.g., the upper pivot mount 64), or other area of a bicycle frame. The first and second mounts 340a, 340b may include first and second apertures 344a, 344b (e.g., through apertures), respectively, sized and shaped to receive a fastener(s) or other structures to secure the first and second support arms 308a, 308b to the upper pivot mount or other area of the bicycle frame.

With continued reference to FIG. 30, the rear rack assembly 300 may include first and second fasteners 348a, 348b (e.g., first and second rack mounting pivot bolts) that may extend at least partially into the first and second apertures 344a, 344b. The first and second fasteners 348a, 348b may include first and second fastener heads 352a, 352b, respectively.

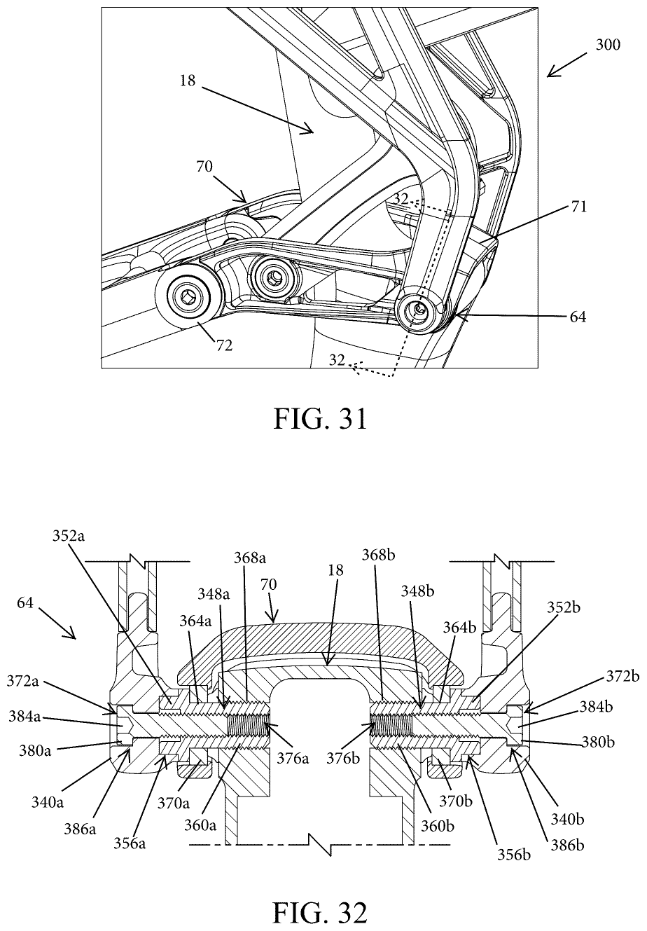

As illustrated in FIG. 32, the first and second apertures 344a, 344b may define first and second recessed regions 356a, 356b (e.g., interior sockets), that are sized and shaped to receive the first and second fastener heads 352a, 352b, respectively. The first and second recessed regions 356a, 356b may be located on interior sides of the first and second mounts 340a, 340b, and thus face inwardly toward each other and toward a bicycle frame (e.g., the main frame 18 of the bicycle frame assembly 16).

With continued reference to FIG. 32, the first and second fasteners 348a, 348b may additionally include first and second distal regions 360a, 360b that extend (e.g., longitudinally) from the first and second fastener heads 352a, 352b, respectively. In some examples, the first and second distal regions 360a, 360b may include first, non-threaded regions 364a, 364b, and also second, threaded regions 368a, 368b.

As seen in FIG. 32, in some examples the first and second distal regions 360a, 360b may extend through the pivot link 70, and the threaded regions 368a, 368b may thread into the main frame 18 (or into a different bicycle frame or different region of a bicycle frame). The non-threaded regions 364a, 364b may act as a bushing and/or otherwise permit or facilitate pivoting movement of the pivot link 70.

In the illustrated example, further bushings or spacers 370a, 370b are positioned between the first and second fasteners 348a, 348b and the pivot link 70. Other examples may include other areas along the first and second fasteners 348a, 348b (or along other components of the rear rack assembly 300) that facilitate pivoting movement of the pivot link 70, and/or may not include the further bushings or spacers 370a, 370b.

With reference to FIGS. 30 and 32, the rear rack assembly 300 may additionally include third and fourth fasteners 372a, 372b (e.g., retention screws or bolts) that are sized and shaped to be coupled (e.g., threaded) to the first and second fasteners 348a, 348b. For example, and as seen in FIG. 32, the first and second fasteners 348a, 348b may include first and second central (e.g., at least partially threaded) apertures 376a, 376b that extend longitudinally within the first and second fasteners 348a, 348b, including for example through the first and second fastener heads 352a, 352b and/or through the distal regions 360a, 360b. The third and fourth fasteners 372a, 372b may be sized and shaped to be inserted at least partially into (e.g., threaded into) the first and second central apertures 376a, 376b.

With continued reference to FIG. 32, in some examples the third and fourth fasteners 372a, 372b may include third and fourth fastener heads 380a, 380b, respectively. The third and fourth fastener heads 380a, 380b may include first and second tool engagement regions 384a, 384b (e.g., recesses or protrusions), respectively, that facilitate the use of a tool to rotate the third and fourth fasteners 372a, 372b. The first and second mounts 340a, 340b may define third and fourth recessed regions 386a, 386b (e.g., sockets), respectively, that are sized and shaped to receive the third and fourth fastener heads 380a, 380b.

As seen in FIG. 32, in some examples the third recessed region 386a may be located on an opposite side of the first mount 340a than the first recessed region 356a. Similarly, the fourth recessed region 386b may be located on an opposite side of the second mount 340b than the second recessed region 356b.

Additionally, and as seen in FIG. 32, in some examples the third and fourth recessed regions 386a, 386b may be sized larger than the third and fourth fastener heads 380a, 380b. Accordingly, the third and fourth fastener heads 380a, 380b may be concealed and/or disposed entirely within the third and fourth recessed regions 386a, 386b.

In some examples, the first and second fasteners 348a, 348b and/or the third and fourth fasteners 372a, 372b may be replaced with alternative first and second fasteners and/or third and fourth fasteners, which may be sized and shaped for example for a different sized bicycle and/or rack assembly and/or pivot link. For example, alternative first and second fasteners may have a larger diameter distal threaded region, or other dimensions in one or more regions, as compared to the first and second fasteners 348a, 348b, to facilitate attachment to a different sized bicycle frame and/or rack assembly and/or pivot link. Alternative third and fourth fasteners may similarly have different diameters or sizes than the illustrated third and fourth fasteners Accordingly, different bicycles and/or rack assemblies (e.g., rear rack assemblies) may use different fasteners.

In some examples, to attach the rear rack assembly 300 to the bicycle frame (e.g., the main frame 18 or other frame), a user may first remove the frame's existing pivot bolt at the upper pivot mount (e.g., at the pivot mount 64), and replace the pivot bolt with the first and second fasteners 348a, 348b. The first and second threaded distal regions 368a, 368b may be extended through the pivot link (e.g., the pivot link 70) and threaded into the bicycle frame (e.g., the main frame 18), and the first and second fastener heads 352a, 352b may be positioned into the first and second recessed regions 356a, 356b (e.g., sockets).

Then, the user may insert the third and fourth fasteners 372a, 372b, and thread them into the threaded first and second central apertures 376a, 376b of the first and second fasteners 348a, 348b, thereby securing the first and second mounts 340a, 340b in place to the bicycle frame at the pivot mount, while still permitting pivoting movement of the pivot link 70.

By anchoring the rear rack assembly 300 to a main frame (e.g., the main frame 18) at an upper pivot mount (e.g., the upper pivot mount 64), the rear rack assembly 300 may support heavier loads more effectively, making it ideal for carrying cargo (e.g., panniers, touring gear, groceries, etc.). This configuration may also eliminate the need to transfer weight to a seatpost, which may not be designed for high vertical loads, thereby reducing stress and potential damage to the seatpost. Additionally, the fastener arrangement described above may facilitate ease of removing and/or replacing the rear rack assembly 300, and securing it to the pivot mount.

In some examples, the fastener arrangement described above for the rear rack assembly 300 may also be used for the rear rack assembly 100 described above. Other examples may include various other manners of attaching the rear rack assembly 100 or the rear rack assembly 300 to a bicycle frame (e.g., with or without the types of fasteners described above, and/or using other types of fasteners, bushings, and/or other structures to couple the rear rack assembly 100 or the rear rack assembly 300 to an upper pivot mount location on a bicycle).

With reference to FIG. 30, in some examples the rear rack assembly 300 may include an adjustable mount assembly 388, positioned adjacent the first ends 328a, 332a of the first and second support arms 308a, 308b (or at other locations along the rear rack assembly 300). The adjustable mount assembly 388 may be similar or identical to the adjustable mount assembly 132 described above.

In some examples, the adjustable mount assembly 388 may include a first housing 392a secured to (or integrally formed with) the first support arm 308a, a second housing 392b secured to (or integrally formed with) the second support arm 308b, and a seatpost clamp 396 removably positioned between the first and second housings 392a, 392b.

In contrast to the adjustable mount assembly 132 described above, the adjustable mount assembly 388 may not include separate mounting plates (such as the first and second mounting plates 134a, 134b described above) that are flipped and removably coupled to the first and second housings 392a 392b. Instead, each of the first and second housings 392a, 392b may themselves include a variety of apertures 396a, 396b, 396c, 396d, etc., that provide for various vertical and/or lateral mounting locations for the seatpost clamp 396.

In some examples, one or more of the apertures 396a, 396b, 396c, 396d, etc. may be threaded, to receive a threaded fastener or fasteners 400 that secure the seatpost clamp 396 in place.

In other examples, the adjustable mount assembly 388 may be identical to the adjustable mount assembly 132 described above, and/or may include separate mounting plates (similar or identical to the mounting plates 134a, 134b).

The seatpost clamp 396 overall may be considered an upper clamp, and may be secured between a seat post (e.g., the seatpost 37 of the bicycle 10) and the first and second housings 392a, 392b. The seatpost clamp 396 may have similar or identical features to those described above and shown in FIG. 8. For example, and as seen in FIG. 30, the seatpost clamp 396 may include a clamping portion 404 and a mounting portion 408 that are coupled together with one or more fasteners 412. Other examples may include other numbers and/or types of arrangements of features defining the seatpost clamp 396.

Similar to the seatpost clamp 138, the seatpost clamp 396 may be moved to numerous different positions relative to the first and second housings 392a, 392b. For example, the seatpost clamp 36 may be secured to the first and second housings 392a, 392b (e.g., with one or more fasteners) and to any of the various apertures 396a, 396b, 396c, 396d, etc. on the first and second housings 392a, 392b to achieve different vertical and/or lateral positions (e.g., three, four, five, or six vertical and/or lateral positions, or other numbers of positions). Additionally, and similar to the seatpost clamp 138, the seatpost clamp 396 may be flipped between an upward position and downward position and then aligned with the apertures 396a, 396b, 396c, 396d, etc. on the first and second housings 392a, 392b.

In some examples, the adjustable mount assembly 388 may provide for a total of six possible total positions, or eight total positions, or ten total positions, or twelve total positions, or other numbers of positions for the seatpost clamp 396, depending upon the number of different apertures provided on the first and second housings 392a, 392b, and the ability of the seatpost clamp 396 to flip between an upward position and a downward position.

In other examples, other numbers of positions may be possible. Additionally, in other examples, the adjustable mount assembly 132 (with its removable mounting plates 134a, 134b) may be used in place of the adjustable mount assembly 388, or vice versa, on the rear rack assembly 100 and/or the rear rack assembly 300.

With reference to FIG. 30, in some examples the rear rack assembly 300 may additionally include a guard component (e.g., fender) 414 that is coupled to the base 304, for example with one or more fasteners 416. The guard component 414 may help to cover and/or guard a rear wheel of a bicycle (e.g., the rear wheel 14). Other examples may not include the guard component 414.

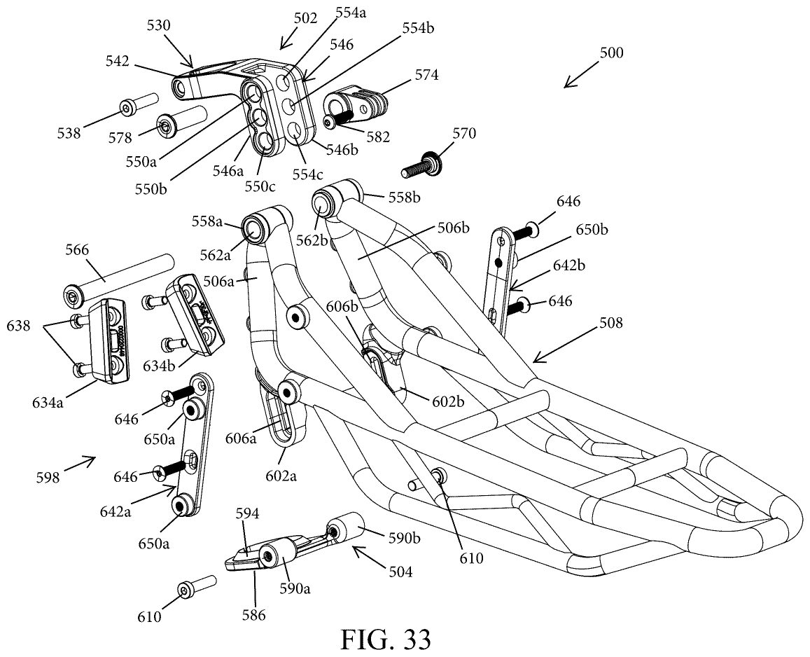

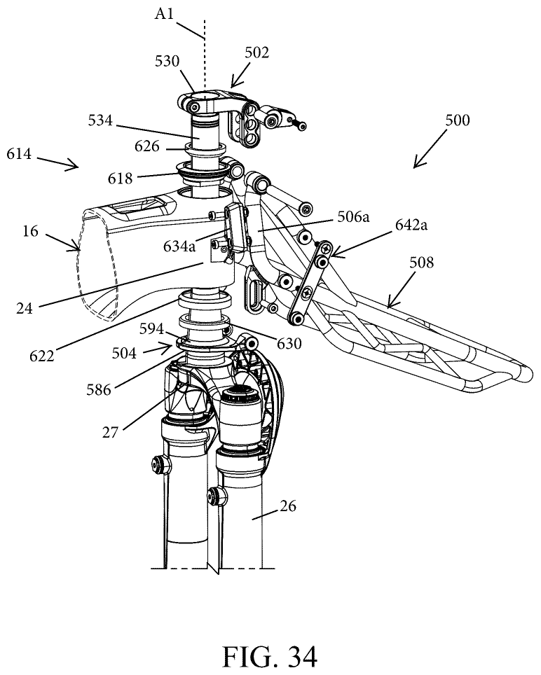

FIGS. 33 and 34 illustrate another example of a front rack assembly 500. The front rack assembly 500 may be coupled to the bicycle 10 (or another bicycle), and may include many of the same components, or components similar to, the front rack assembly 200.

In some examples, and as seen in FIG. 33, the front rack assembly 500 may include an upper accessory mount 502, a lower accessory mount 504, first and second mounting struts 506a, 506b (e.g., secured to the upper and lower accessory mounts 502, 504), and/or a front rack base 508 (e.g., secured to or integrally formed as a single piece with the first and second mounting struts 506a, 506b).

With continued reference to FIG. 33, the upper accessory mount 502 may include a steerer tube collar 530 coupled to the first and second mounting struts 506a, 506b. The steerer tube collar 530 may be clamped to an upper portion of a steerer tube 534 (FIG. 34), for example by a collar bolt 538, or with other fasteners or clamps.

In some examples, and as seen in FIG. 33, the steerer tube collar 530 may generally include a clamping region 542 that clamps to the steerer tube 534, and a mounting region 546 having first and second arms 546a, 546b that extend away from the clamping region 542. The first arm 546a may include various mounting apertures 550a, 550b, 550c, etc., and the second arm 546b may similarly include various mounting apertures 554a, 554b, 554c.

The mounting apertures of the first and second arms 546a, 546b may facilitate a vertical adjustment of the steerer tube collar 530 relative to the first and second mounting struts 506a, 506b, for example to facilitate use of the front rack assembly 500 on bicycles of different sizes. Other examples may include other numbers or arrangements of mounting apertures (e.g., only a single mounting aperture, or two apertures, or four apertures, etc.).

In some examples, the first and second arms 546a, 546b of the mounting region 546 may extend in an elongate direction (e.g., vertically), and may extend for example perpendicular to the clamping region 542. In other examples, the first and second arms 546a, 546b may extend at an oblique angle. Additionally, in other examples the upper accessory mount may include only a single arm with one or more apertures, or more than two arms, or may not include any arms.

With continued reference to FIG. 33, the first and second mounting struts 506a, 506b may include first and second strut mounting regions 558a, 558b, respectively (e.g., mounting bosses). The first and second strut mounting regions 558a, 558b may have first and second through-holes 562a, 562b, respectively. A mounting nut 566 and a mounting bolt 570 (or other fasteners) may may pass through the first and second through-holes 562a, 562b to releasably couple the steerer tube collar 530 to the first and second struts 506a, 506b.

In the illustrated example, the first and second mounting struts 506a, 506b are integrally formed as a single piece with the front rack base 508. Accordingly, the first and second struts 506a, 506b and the front rack base 508 may form a single, monolithic, rigid structure. The steerer tube collar 530 may thus be coupled (e.g., pivotally coupled) to this overall rigid structure via the mounting region 546, and also coupled (e.g., clamped) to the steerer tube 534 via the clamping region 542. In other examples, the first and second struts 506a, 506b may be separately coupled (e.g., fixed) to the front rack base 508.

With continued reference to FIG. 33, in some examples the front rack assembly 500 may include an auxiliary accessory mount 574 that facilitates a mounting location for other an accessory, such as an action camera or a light assembly (e.g., the light assembly 254). As seen in FIG. 30, the auxiliary accessory mount 574 may be coupled to the mounting region 546 via a separate mounting bolt 578 (or other fastener).

In some examples, the separate mounting bolt 578 may pass through one or more of the mounting apertures 550a, 550b, 550c, 554a, 554b, 554c, etc. on the first and second arms 546a, 546b, such that the auxiliary accessory mount 574 is positioned between the first and second arms 546a, 546b. Additionally, and as illustrated in FIG. 30, in some examples a further fastener 582 may extend through an accessory to couple the accessory to the auxiliary accessory mount 574.

Other examples may not include the auxiliary accessory mount 574, or may include an auxiliary accessory mount having other components and/or features than that illustrated.

With reference to FIG. 33, in some examples the lower accessory mount 504 may include a base portion 586, and a pair of lower mounting bosses 590a, 590b that protrude from the base portion 586. Similar to the base portion 260 described above, the base portion 586 may comprise a substantially annular shape (e.g., a substantially annular disk) that substantially encircles a lower portion of the steerer tube 534 (FIG. 34). Other examples may include different shapes than that shown, and/or may not include two lower mounting bosses 590a, 590b (e.g., may include other mounting regions or structures, or other numbers of mounting bosses).

In some examples, and similar to the base portion 260 described above, the base portion 586 may include a raised portion 594 (e.g., having a beveled and/or frustoconical shape) that is dimensioned to be received within and engage (e.g., in a keyed or interlocking manner) for example a portion (e.g., race) of a lower headset bearing of a headset for a bicycle (e.g., the bicycle 10). In this regard, and as described in further detail below, the base portion 586 may be dimensioned to act as and replace a compression ring and/or fork crown race. For example, the base portion 586 may provide compressive axial force that compresses headset bearings and/or other components of a headset assembly, to facilitate connection of a front fork (e.g., the front fork 26) to a main frame (e.g., the main frame 18), and/or to facilitate a handlebar assembly (e.g., the handlebar assembly 28) rotating to turn a front wheel (e.g., the front wheel 12).

With reference to FIG. 33, in some examples the front rack assembly 500 may include a base portion mounting assembly 598 that facilitates adjustment (e.g., vertical adjustment) of the base portion 586 relative to the overall rigid structure formed by the first and second struts 506a, 506b and the front rack base 508, for example to accommodate bicycles of different sizes.

In some examples, the base portion mounting assembly 598 may include first and second projections 602a, 602b that extend below the front rack base 508 and include first and second slotted orifices 606a, 606b, respectively. One or more fasteners 610 (or other structures) may extend through the first and second slotted orifices 606a, 606b, and into the lower mounting bosses 590a, 590b of the lower accessory mount 504.

Similar to the first and second slotted orifices 282a, 282b described above, the first and second slotted orifices 606a, 606b may facilitate use of the front rack assembly 500 on bicycles of various sizes, by allowing the lower accessory mount 504 to be moved (e.g., vertically) toward or away from the upper accessory mount 502. Other examples may not include the first and second slotted orifices 606a, 606b.

In some examples, the first and second projections 602a, 602b may be integrally formed as part of the front rack base 508 (e.g., co-molded therewith, or formed from the same material as the front rack base 508), rather than being separate projections that are coupled (e.g., with fasteners) front rack base 508.

Other examples may include various other shapes, sizes, and arrangements of projections, slotted orifices, or other structures that facilitate a vertical adjustment of the lower accessory mount 504.

As described above, the base portion 586 may be dimensioned to act as and replace a compression ring and/or fork crown race. For example, and with reference to FIG. 34, a bicycle (e.g., the bicycle 10 or other bicycle) may include a headset assembly 614 having an upper headset bearing 618 (e.g., an upper bearing), a lower headset bearing 622 (e.g., a lower bearing), an upper bearing race 626, and/or a lower bearing race 630. The upper and lower headset bearings 618, 622 may facilitate rotation of a fork assembly about a steering axis A1 as seen in FIG. 34 (e.g., an axis that passes through the head tube 24).

As seen in FIG. 34, the base portion 586 of the lower accessory mount 504 may be located below the lower headset bearing 622 (and for example the lower bearing race 630). Additionally, and as seen in FIG. 34, the steerer tube collar 530 may be positioned, for example, above the upper headset bearing 618 (and for example the upper bearing race 626). In some examples, the lower accessory mount 504 (and/or the lower accessory mount 204 described further above) may encircle a steerer tube, but may not encircle a head tube and/or a bearing.

With continued reference to FIG. 34, the steerer tube collar 530 may be positioned below a handlebar stem (e.g., the handlebar stem 30 of the bicycle 10, seen in FIG. 1), for example in a location that is commonly occupied by headset spacers. In this regard, the steerer tube collar 530 may essentially act as a headset spacer until the upper and lower headset bearings 618, 622 are preloaded (e.g., by the raised portion 594 of the base portion 586), at which time the steerer tube collar 530 may be clamped onto the steerer tube 534.

Other examples may include other arrangements of headset bearings, races, and/or other structures forming a headset assembly. Additionally, in other examples the base portion 586 may not provide compression and/or act as a compression ring as described above.

With reference to FIGS. 33 and 34, in some examples the front rack assembly 500 may include one or more stop elements that inhibit or prevent the first and second struts 506a, 506b and/or the front rack base 508 from contacting and/or potentially damaging a bicycle frame (e.g., the main frame 18). For example, and as seen in FIGS. 33 and 34, the front rack assembly 500 may include a first stop element 634a (e.g., right stop element) that is coupled (e.g., co-molded and/or fixed via one or more fasteners) to the first strut 506a (e.g., right strut), and/or a second stop element 634b (e.g., left stop element) that is coupled (e.g., co-molded and/or fixed via one or more fasteners) to the second strut 506b (e.g., left strut).

Fasteners 638 may be used, for example, to couple the first and/or second stop element 634a, 634b in place. In other examples, the first and second stop elements 634a, 634b may be coupled to front rack base 508, and/or may be integrally formed (e.g., co-molded) to the front rack base 508. Other examples may not include stop elements, or may include other numbers, arrangements, and/or positions of stop elements than that illustrated.

With reference to FIG. 33, in some examples the front rack assembly 500 may include first and/or second water bottle cage adapters 642a, 642b that are each coupled (e.g., fixed via one or more fasteners 646) to the front rack base 508 (e.g., on opposite sides of the front rack base 508). In some examples, the first and/or second water bottle cage adapter 642a, 642b includes an elongate rigid bar. Other examples may include other shapes and/or sizes.

The first and second water bottle cage adapters 642a, 642b may include one or more mounting regions 650a, 650b that are sized and shaped to couple to a water bottle cage (e.g., via a fastener or fasteners that extends through the water bottle cage and the mounting region(s) 650a, 650b). In the illustrated example, the first water bottle cage adapter 642a includes two mounting regions 650a, and the second water bottle cage adapter 642b includes two mounting regions 650b (one not being visible in FIG. 33).

Other examples may include other numbers and/or arrangements of mounting regions for the first water bottle cage adapter 642a and/or the second water bottle cage adapter 642b. Additionally, in the illustrated example the fasteners 646 alternate with the mounting regions 650a, 650b along the first and second water bottle cage adapters 642a, 642b. Other examples may include other arrangements or patterns of fasteners and/or mounting regions.

In yet other examples, the first and second water bottle cage adapters 642a, 642b may additionally, or alternatively, be used to couple a different accessory to the front rack assembly 500. For example, the first and second water bottle cage adapters 642a, 642b and their mounting regions 650a, 650b may be used to couple a pump or other accessory to the front rack assembly 500.

In the illustrated example, the first and second water bottle cage adapters 642a, 642b are generally rigid bars, although other examples may include other shapes and sizes. Some examples may not include water bottle cage adapters. In yet other examples, the first and/or second water bottle cage adapter 642a, 642b may be integrally formed as part of the front rack base 508 itself, rather than being separately coupled thereto with fasteners 646.

In some examples, mounting the front rack assembly 500 to a bicycle (e.g., the bicycle 10 or other bicycle) may be conducted in a similar or identical manner as described above for the front rack assembly 200. For example, the mounting may be initiated by mounting the upper accessory mount 502 and the lower accessory mount 504 to a fork assembly (e.g., to the steerer tube 534 as seen in FIG. 34). In the illustrated example, this is accomplished for example by removing the fork assembly from the head tube 24, sliding the lower accessory mount 504 onto the steerer tube 534, and re-inserting the steerer tube 534 back into the head tube 24 such that the lower accessory mount 504 is sandwiched between the fork crown 27 and the lower headset bearing 622 (and also for example the lower bearing race 630). The upper accessory mount 502 may then be slid onto the upper end of the steerer tube 534 along with any needed headset spacers followed by the handlebar stem 30.

Next, the mounting struts 506a, 506b may be secured to two of the mounting apertures 550a, 550b, 550c, 554a, 554b, 554c of the mounting region 546 using the mounting nut 566 and the mounting bolt 570. The mounting struts 506a, 506b may also be secured to the lower mounting bosses 590a, 590b using the fasteners 610.

In some examples, the auxiliary accessory mount 574 may then be coupled to the mounting region 546, using for example the separate mounting bolt 578.

Other examples may include other steps, or orders of steps, of mounting the front rack assembly 500 or the front rack assembly 200 as described above.

Some of the examples may be further described by reference to the following numbered clauses:
1. A bicycle comprising:
   a front wheel;
   a rear wheel;
   a main frame supported by the front wheel and by the rear wheel;
   a rear suspension pivotally coupled to the main frame at a pivot axis; and
   a rear rack assembly secured at the pivot axis.
2. The bicycle of clause 1, wherein the rear suspension is pivotally secured to the main frame by a fastener, and wherein the rear rack assembly is secured at the pivot axis by the fastener.
3. The bicycle of clause 1 or clause 2, wherein the main frame includes a seat tube, and wherein the rear rack assembly includes a left mount and a right mount positioned on opposing sides of the seat tube, the left mount and the right mount being aligned with the pivot axis.
4. The bicycle of any of the preceding clauses, wherein the rear suspension includes a chainstay pivotally coupled to the main frame at a lower pivot, a seatstay pivotally coupled to the chainstay, and an upper link pivotally coupled to the seatstay and pivotally coupled to the main frame at an upper pivot, wherein the upper pivot defines the pivot axis.
5. The bicycle of clause 4, further comprising a shock coupled between the upper link and the main frame.
6. The bicycle of any of the preceding clauses, wherein the rear rack assembly includes a mount defining a first aperture, wherein the first aperture defines an interior socket, wherein the rear rack assembly further includes a first fastener having a head sized and shaped to be received by the interior socket.
7. The bicycle of claim 6, wherein the first fastener defines a second aperture extending longitudinally within the first fastener, and wherein the rear rack assembly includes a second fastener sized and shaped to be inserted through the mount and threaded into the second aperture of the second fastener.
8. A bicycle comprising:
   a front wheel;
   a rear wheel;
   a main frame supported by the front wheel and by the rear wheel; and
   a rack assembly coupled to and supported by the main frame, the rack assembly including a rack base and an adjustable mount assembly coupled to the rack base, the adjustable mount assembly configured to facilitate attaching the rack assembly to different frame sizes.
9. The bicycle of clause 8, wherein the adjustable mount assembly includes a plate capable of being secured to the rack base in one of a first position and a second position rotated relative to the first position.
10. The bicycle of clause 9, wherein the second position is rotated 180 degrees relative to the first position.
11. The bicycle of clause 9 or clause 10, wherein the adjustable mount assembly further includes an upper clamp capable of being secured to the plate in one of a third position and a fourth position rotated relative to the third position.
12. The bicycle of clause 11, wherein the fourth position is rotated 180 degrees from the third position.
13. The bicycle of clause 11 or clause 12, further comprising a seatpost supported by the main frame and a seat supported by the seatpost, wherein the upper clamp is secured between the seatpost and the plate.
14. The bicycle of any of clauses 11-13, wherein the plate includes three different mounting locations for the upper clamp.
15. The bicycle of clause 14, wherein the upper clamp may be moved to any one of twelve different mounting positions based on (1) rotating the plate relative to the rack base between the first position and the second position; (2) rotating the upper clamp relative to the plate between the third position and the fourth position; and (3) securing the upper clamp to one of the three different mounting locations on the plate.
16. The bicycle of any of clauses 8-15, wherein the adjustable mount assembly includes a first housing having a first plurality of apertures and a second housing having a second plurality of apertures, wherein the adjustable mount assembly further includes an upper clamp capable of being selectively secured to the first plurality of apertures and the second plurality of apertures to achieve different lateral and/or vertical positions of the upper clamp.
17. The bicycle of clause 16, wherein the upper clamp is further configured to be flipped between an upward position and a downward position.
18. The bicycle of clause 17, wherein the upper clamp is sized and shaped to be clamped to a seat tube.
19. The bicycle of clause 8, further comprising a rear suspension pivotally coupled to the main frame at a pivot axis, wherein the rack assembly is a rear rack assembly, wherein the rear rack assembly is secured at the pivot axis.
20. A method of adjusting a bicycle rack assembly having a rack base and an adjustable mount secured to the rack base in a first position, comprising:
   detaching the adjustable mount from the rack base;
   rotating the adjustable mount from the first position to a second position different than the first position; and
   securing the adjustable mount to the rack base in the second position.
21. A bicycle comprising:
   a front wheel;
   a rear wheel;
   a frame assembly supported by the front wheel and by the rear wheel, the frame assembly including a main frame and a fork assembly rotatably secured to the main frame, the fork assembly including a fork crown;
   a lower bearing that facilitates rotation of the fork assembly relative to the main frame about a steering axis; and
   a lower accessory mount including a base portion sandwiched between the fork crown and the lower bearing.
22. The bicycle of clause 21, wherein the base portion comprises a substantially annular disk.
23. The bicycle of clause 22, wherein the substantially annular disk comprises a compression ring.
24. The bicycle of any of clauses 21-23, further comprising a mounting boss protruding from the base portion, wherein the mounting boss comprises a through-hole adapted to secure a front rack.
25. The bicycle of clause 24, further comprising a front rack assembly secured to the mounting boss and positioned substantially over the front wheel.
26. The bicycle of any of clauses 21-25, wherein the lower accessory mount is separable from the fork crown.
27. The bicycle of any of clauses 21-26, further comprising an upper bearing that facilitates rotation of the fork assembly relative to the main frame about the steering axis, and further comprising an upper accessory mount positioned above the upper bearing and secured to a steerer tube.
28. The bicycle of clause 27, further comprising a front rack assembly secured to the upper accessory mount and positioned substantially over the front wheel.
29. The bicycle of clause 27 or clause 28, wherein the upper accessory mount is positioned below a handlebar stem, and is configured to be a spacer between the handlebar stem and the upper bearing.
30. The bicycle of any of clauses 27-29, further comprising a light assembly coupled to the upper accessory mount.
31. The bicycle of clause 30, wherein the light assembly is part of an overall headlight shield assembly, wherein the headlight shield assembly includes a shield mount, and a shield body supported by the shield mount, wherein the light assembly is mounted to the shield body.
32. The bicycle of any of clauses 21-31, further comprising an upper accessory mount, wherein the lower accessory mount and the upper accessory mount each form part of a front rack assembly, wherein the front rack assembly further includes a left mounting strut, a right mounting strut, and a front rack base.
33. The bicycle of clause 32, wherein the upper accessory mount includes a clamping region and a mounting region, wherein the clamping region is sized and shaped to be clamped to a steerer tube.
34. The bicycle of clause 33, wherein the mounting region includes first and second arms having first and second apertures to facilitate a vertical adjustment of the upper accessory mount relative to the front rack base.
35. The bicycle of clause 34, wherein the front rack assembly include a projection having a slotted orifice, wherein the lower accessory mount is coupled to the projection and is configured to move vertically via the slotted orifice.
36. The bicycle of any of clauses 32-35, wherein the front rack assembly includes a left stop element coupled to the left mounting strut and a right stop element coupled to the right mounting strut.
37. The bicycle of any of clauses 32-36, wherein the front rack assembly includes a water bottle cage adapter coupled to the front rack base.
38. The bicycle of clause 37, wherein the water bottle cage adapter includes an elongate rigid bar and a mounting region sized and shaped to couple to a water bottle cage.
39. The bicycle of any of clauses 21-38, further comprising a lower bearing race for the lower bearing, wherein the base portion is sandwiched between the fork crown and the lower bearing race.
40. The bicycle of clause 21, further comprising an upper accessory mount, wherein a front rack base is coupled to both the upper accessory mount and the lower accessory mount.

Various features and advantages of the disclosure are set forth in the following claims.

1. A bicycle comprising:
a front wheel;
a rear wheel;
a main frame supported by the front wheel and by the rear wheel;
a rear suspension pivotally coupled to the main frame at a pivot axis; and
a rear rack assembly secured at the pivot axis.

2. The bicycle of claim 1, wherein the rear suspension is pivotally secured to the main frame by a fastener, and wherein the rear rack assembly is secured at the pivot axis by the fastener.

3. The bicycle of claim 1, wherein the main frame includes a seat tube, and wherein the rear rack assembly includes a left mount and a right mount positioned on opposing sides of the seat tube, the left mount and the right mount being aligned with the pivot axis.

4. The bicycle of claim 1, wherein the rear suspension includes a chainstay pivotally coupled to the main frame at a lower pivot, a seatstay pivotally coupled to the chainstay, and an upper link pivotally coupled to the seatstay and pivotally coupled to the main frame at an upper pivot, wherein the upper pivot defines the pivot axis.

5. The bicycle of claim 4, further comprising a shock coupled between the upper link and the main frame.

6. The bicycle of claim 1, wherein the rear rack assembly includes a mount defining a first aperture, wherein the first aperture defines an interior socket, wherein the rear rack assembly further includes a first fastener having a head sized and shaped to be received by the interior socket.

7. The bicycle of claim 6, wherein the first fastener defines a second aperture extending longitudinally within the first fastener, and wherein the rear rack assembly includes a second fastener sized and shaped to be inserted through the mount and threaded into the second aperture of the second fastener.

8. A bicycle comprising:
a front wheel;
a rear wheel;
a main frame supported by the front wheel and by the rear wheel; and
a rack assembly coupled to and supported by the main frame, the rack assembly including a rack base and an adjustable mount assembly coupled to the rack base, the adjustable mount assembly configured to facilitate attaching the rack assembly to different frame sizes.

9. The bicycle of claim 8, wherein the adjustable mount assembly includes a plate capable of being secured to the rack base in one of a first position and a second position rotated relative to the first position.

10. The bicycle of claim 9, wherein the second position is rotated 180 degrees relative to the first position.

11. The bicycle of claim 9, wherein the adjustable mount assembly further includes an upper clamp capable of being secured to the plate in one of a third position and a fourth position rotated relative to the third position.

12. The bicycle of claim 11, wherein the fourth position is rotated 180 degrees from the third position.

13. The bicycle of claim 11, further comprising a seatpost supported by the main frame and a seat supported by the seatpost, wherein the upper clamp is secured between the seatpost and the plate.

14. The bicycle of claim 11, wherein the plate includes three different mounting locations for the upper clamp.

15. The bicycle of claim 14, wherein the upper clamp may be moved to any one of twelve different mounting positions based on (1) rotating the plate relative to the rack base between the first position and the second position; (2) rotating the upper clamp relative to the plate between the third position and the fourth position; and (3) securing the upper clamp to one of the three different mounting locations on the plate.

16. The bicycle of claim 8, wherein the adjustable mount assembly includes a first housing having a first plurality of apertures and a second housing having a second plurality of apertures, wherein the adjustable mount assembly further includes an upper clamp capable of being selectively secured to the first plurality of apertures and the second plurality of apertures to achieve different lateral and/or vertical positions of the upper clamp.

17. The bicycle of claim 16, wherein the upper clamp is further configured to be flipped between an upward position and a downward position.

18. The bicycle of claim 17, wherein the upper clamp is sized and shaped to be clamped to a seat tube.

19. The bicycle of claim 8, further comprising a rear suspension pivotally coupled to the main frame at a pivot axis, wherein the rack assembly is a rear rack assembly, wherein the rear rack assembly is secured at the pivot axis.

20. A method of adjusting a bicycle rack assembly having a rack base and an adjustable mount secured to the rack base in a first position, comprising:
detaching the adjustable mount from the rack base;
rotating the adjustable mount from the first position to a second position different than the first position; and
securing the adjustable mount to the rack base in the second position.
